(19) United States
(12) Patent Application Publication
(10) Pub. No.: US 2006/0126916 A1
(43) Pub. Date: Jun. 15, 2006

(54) Template generating method and apparatus of the same, pattern detecting method, position detecting method and apparatus of the same, exposure apparatus and method of the same, device manufacturing method and template generating program

(75) Inventor: Yuji Kokumai, Tokyo (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 11/285,171

(22) Filed: Nov. 23, 2005

Related U.S. Application Data
(63) Continuation of application No. PCT/JP04/06825, filed on May 20, 2004.

(30) Foreign Application Priority Data
May 23, 2003 (JP) 2003-146409
May 30, 2003 (JP) 2003-153821
Jan. 20, 2004 (JP) 2004-011901

(51) Int. Cl. G06K 9/00

(52) U.S. Cl. 382/151

(57) ABSTRACT

A method enabling easy generation of a template handling pattern deformation due to optical conditions or process conditions and suitably detecting pattern position is disclosed. A first method extracts a feature component, that is, symmetry, not affected by optical conditions etc. from the pattern image information and uses it as a template. At the time of pattern detection, image information is projected into a symmetry feature space and matching performed in the feature space to detect a pattern. Suitable template matching can be performed with being affected by pattern deformation. A second method generates a model of a pattern from input pattern data, calculates a plurality of pattern images (virtual models) obtained by imaging of the model for each imaging condition using an image deformation simulator, and determines a template considering their average or correlation.

### BACKGROUND OF THE INVENTION

1. Field of the Invention

The present invention relates to a template generating method, apparatus, and program suitable for application for positioning a wafer, reticle, etc. in a lithography process when producing for example a semiconductor element or other electronic device, a pattern detecting method detecting a mark or other pattern using a generated template, a position detecting method and apparatus for detecting a position of a wafer etc. based on a detected mark etc., an exposure method and apparatus for exposure based on the detected position of a wafer etc., and a device manufacturing method for manufacturing an electronic device by performing such exposure.

2. Description of the Related Art

In the process for manufacture of for example a semiconductor element, liquid crystal display element, plasma display element, thin film magnetic head, or other electronic device (below, referred to all together as an “electronic device”), an exposure apparatus is used to repeatedly project and expose images of fine patterns formed on a photomask or reticle (below, these being referred to all together as a “reticle”) on a semiconductor wafer, glass plate, or other substrate coated with a photoresist or other photosensitizer. When performing this projection exposure, for example, a step-and-repeat type exposure apparatus etc. matches the position of the substrate with the position of the images of the patterns formed on the reticle with a high precision.

In recent years, improvement of the precision of this positioning between the substrate and pattern images has been demanded. In particular, in production of semiconductor elements, improvement in the degree of integration of semiconductor elements has been accompanied with greater miniaturization of the patterns formed. To produce a semiconductor element having the desired performance, extremely high precision positioning is now demanded. This positioning in an exposure apparatus is performed by detecting an alignment mark or other mark formed on the substrate or reticle by an alignment sensor to obtain position information of the mark and by using this to detect the position of the substrate etc. and control its position.

Various methods are being used as methods for detecting a mark to obtain position information, but in recent years, an FIA (field image alignment) type alignment sensor detecting the position of a mark by an image processing system has come into use. This detects a mark from an image signal of the surface of the substrate near the mark. As the processing algorithm used when detecting the mark (detecting the mark position), edge detection, correlation computation, etc. are known. As one technique of correlation computation, the method of using a template image of a mark prepared in advance to detect a mark and using this to detect the position of the mark is also known (for example, see Japanese Patent Publication (A) No. 2001-210577).

However, most alignment marks are comprised of combinations of lines of certain line widths as for example shown in FIG. 25A. FIG. 25B is a cross-sectional view (XZ view) at an A-A′ position of a line shown in FIG. 25A. Such a mark changes to various shapes in accordance with the process conditions applied. For example, a mark may be damaged while going through a plurality of exposure processes making it difficult to maintain the shape as designed or the shape at the time of initial formation. Further, the thickness of the resist film coated over the mark may cause the shape of the mark as observed to change. Further, depending on the kind of processing (coating, CMP, etc.) the substrate is subjected to, the way a mark formed on the substrate is viewed may change.

Further, when obtaining an image of such an alignment mark a s image information, depending on the optical conditions etc. at the time of imaging (the conditions at the time of the imaging being referred to overall as simply the “optical conditions”), even when obtaining an image of the same mark, the mark will be appear as various mark images such as shown in for example FIG. 26. Specifically, differences between systems with respect to the aberration of the imaging lens, the numerical aperture (NA) of the imaging system, the luminance or focal position etc. at the time of imaging, or other factors or changes at different imaging operations at the same imaging system (changes in the imaging conditions) will greatly influence the shape of the mark image obtained by the imaging (waveform signal of mark). Further, the shape of the mark image (waveform signal) at the time of imaging will sometimes differ depending upon the line width of the mark (line pattern) or other aspects of the structure of the mark.

To deal with such deformation of the mark image, sometimes the method is adopted of subjecting the obtained image information to edge extraction, binarization, or other pre-processing to absorb the deformation. However, the method of performing edge extraction, binarization, or other pre-processing is complicated in processing and has insufficient points in terms of the processing performance such as the difficulty in detection of the edge positions. Further, the problem arises of the difficulty in determining a suitable template. This is therefore not an effective countermeasure. Further, sometimes the mark image (waveform) is kept from greatly changing in shape by strictly adjusting the focus for the image processing, controlling the resist film to a constant thickness with a high precision at the time of coating, or taking other steps. However, the method of configuring the system or mark so as to prevent the mark image from changing in shape is limited technologically wise and increases the cost. Further, if trying to realize this, in many cases the problem of imposing limitations on the mark structure ends up arising. This therefore cannot be said to be an effective method.

On the other hand, to deal with such deformation of the mark image, the method of generating a template considering optical aberration of the imaging system etc. and using this for matching has been disclosed (for example, see Japanese Patent Publication (A) No. 10-97983).

Further, the method of preparing a plurality of such templates considering deformation is frequently used. However, the method of adaptively generating templates and using them for matching has the problem, first off, of time being taken for generating the templates.

In the past, in the method of using template matching to detect a mark, there was a demand to be able to simply set a desired mark as a template, in other words, to set a desired pattern for detection by the alignment sensor. Specifically, for example, sometimes it is desired to use a pattern included in a circuit pattern (device pattern) to be exposed instead of an alignment mark. Further, for example, sometimes the user of the exposure apparatus desires to directly form the desired information, identification mark, etc. on the substrate by an intuitively understandable letter etc. and use this for detection. Further, as explained above, when for example the alignment mark itself greatly deforms etc., sometimes it is desired to generate a template based on the image of the deformed pattern obtained from the actual substrate and enable this to be detected.

However, even if registering for example design pattern data, letter pattern data input by the user etc. by handwriting, pattern data and letter data input by the user etc. from a CAD etc., pattern data obtained by imaging from the actual substrate etc., this cannot be used as an effective template. As explained above, a pattern obtained by imaging by an alignment system is deformed compared with the image of the actual pattern. Therefore, to generate an effective template, it is necessary to generate a template considering at least such deformation. In the past, such a template was generated by an operator well versed in the features of the imaging system etc. performing the processing (for example, the method disclosed in Japanese Patent Publication (A) No. 10-97983) or was generated by analyzing a large number of actual imaged patterns. It was not possible to easily generate an effective template from a small number of patterns simply stored by the user of the exposure apparatus.

Further, when generating and storing a plurality of templates for a single pattern so as to deal with deformation of the pattern, it is necessary to suitably select the stored template. That is, to enable various types of deformation to be handled by as small a number of templates as possible, it is necessary to suitably select the patterns. If not, there is the possibility that despite a large number of templates being stored, a situation may arise where tolerance against deformation cannot be secured. If trying to deal with deformation by further adding templates in such a situation, it would be necessary to store a huge number of templates. As a result, a large capacity storage means would become necessary for storing the templates and the processing time for the template matching would become long.

However, in the conventional template generating method and selection method, it is necessary to prepare individual templates even for example for alignment marks with substantially the same basic geometric structures but different line widths. It is difficult to say that suitable templates sufficient to handle deformation are generated. Therefore, it is also difficult to say that templates able to handle various deformation are selected. Note that this is also a condition demanded when for example the templates are generated by the user etc. From this viewpoint as well, it is difficult for users etc. to simply generate templates.

### SUMMARY OF THE INVENTION

An object of the present invention is to provide a template generating method, template generating apparatus, and template generating program for generating a template not changing due to deformation of the image of a mark (photoelectric conversion signal) due to differences in optical conditions or process conditions etc., that is, a template dealing with such deformation. Further, the object is to provide a template generating method, template generating apparatus, and template generating program enabling such a template to be easily generated from various input sources.

Further, another object of the present invention is to provide a pattern detecting method enabling a pattern for detection set by any method to be suitably detected while absorbing any deformation of the pattern (mark) by using a template not changing due to deformation of the image of a mark (photoelectric conversion signal) due to differences in optical conditions or process conditions etc. Further, another object of the present invention is to provide a position detecting method and position detecting apparatus enabling a pattern for detection set by any method to be detected using a template not changing due to deformation of the image of a mark (photoelectric conversion signal) due to differences in optical conditions or process conditions etc. and thereby enabling suitable detection of the position of the pattern in accordance with the deformation of the pattern.

Still another object of the present invention is to provide an exposure method and exposure apparatus enabling the position of a pattern for detection set by any method to be detected using a template not changing due to deformation of the image of a mark (photoelectric conversion signal) due to differences in optical conditions or process conditions etc., enabling the exposure position of the substrate etc. to be detected, and enabling suitable exposure at a desired position of the substrate etc. Further, another object of the present invention is to provide a device manufacturing method enabling a pattern for detection set by any method to be detected using a template not changing due to deformation of the image of a mark (photoelectric conversion signal) due to differences in optical conditions or process conditions etc., enabling suitable exposure at a desired position of the substrate etc., and thereby enabling suitable manufacture of an electronic device.

To achieve the objects, the template generating method according to the present invention provides a method for generating a template used for template matching with a photoelectric conversion signal, including a step of obtaining an image of an object to obtain a photoelectric conversion signal (step S101), a step of extracting from the photoelectric conversion signal a feature component maintaining a predetermined state without being affected by at least one or both of the optical conditions at the time of obtaining the photoelectric conversion signal and process conditions given to the object from which the photoelectric conversion signal is obtained (step S102), and a step of holding the extracted feature component as the template (step S103) (see FIG. 10).

According to this template generating method, the photoelectric conversion signal of a mark is copied to a desired feature space having as a component an element not affected by the optical conditions or process conditions, the mark is defined as a feature value in this feature space, and this is used as the template data (simply referred to as “template”). Therefore, this template is information not affected by the optical conditions or the process conditions. The content of the information will never change due to the optical conditions or process conditions. Further, there is no need to hold a plurality of templates to handle the differences in the conditions. Further, if copying the photoelectric conversion signal obtained from a wafer to be processed into a feature space defining this template information and performing template matching in this feature space, it is possible to match an obtained photoelectric conversion signal with a template in a state not affected by the optical conditions or process conditions. That is, it is possible to detect a mark and, based on the detection results, detect the position of the mark without being affected by these conditions.

Preferably, the feature component includes symmetry relating to a plane of symmetry, axis of symmetry, or center of symmetry defined by a predetermined function, and the predetermined state is a state where the plane of symmetry, the axis of symmetry, or the center of symmetry does not change regardless of at least one or both of the differences of the optical conditions and differences of the process conditions. Further, preferably, the symmetry is extracted by subjecting the photoelectric conversion signal to reversed autocorrelation processing (inverted autocorrelation processing). Symmetry is a feature resistant to the effects of optical conditions and process conditions. Further, symmetry can be easily detected by finding the inverted autocorrelation value and the correlation value can be found as a feature value. Therefore, symmetry may be used to suitably and easily match a photoelectric conversion signal obtained by imaging in the feature space with a template.

Further, as a suitable specific example, the optical conditions include at least one or both of the focus state at the time of obtaining the photoelectric conversion signal in the step of obtaining the photoelectric conversion signal and conditions relating to the imaging system used for obtaining the photoelectric conversion signal (for example, the aberration, NA, or other conditions of the imaging optical system). As another preferable specific example, the process conditions in dude conditions relating to a thin film coated on the object (for example, the thickness, material, etc. of the film).

As still another preferable specific example, a predetermined range near the plane of symmetry, the axis of symmetry, or the center of symmetry is excluded from the photoelectric conversion signal for detection of the feature component, and the feature component is extracted from the photoelectric conversion signal of a predetermined area outside of the plane of symmetry, the axis of symmetry, or the center of symmetry of this range. By configuring the system in this way, it is possible to easily exclude from the scope of the processing for detection of symmetry for example patterns of widths less than the width of the lines forming the mark and other patterns clearly identifiable as noise. That is, it is possible to easily perform so-called “noise removal”. Further, since the range of processing can be limited, the processing time for feature extraction can also be shortened. That is, it is possible to efficiently extract a suitable feature and as a result possible to precisely detect the position of a desired mark.

Further, a pattern detecting method according to the present invention obtains an image of an area for detection on an object, extracts from the obtained photoelectric conversion signal of the area for detection the feature component extracted when generating a template according to the above-mentioned template generating method according to the present invention, computes correlation between the extracted feature component and a template generated by the above-mentioned template generating method according to the present invention, and detects the presence of a pattern corresponding to the template in the area for detection based on the results of the correlation computation.

Further, the position detecting method according to the present invention obtains an image of an area for detection on an object, extracts from the obtained photoelectric conversion signal of the area for detection the feature component extracted when generating a template according to the above-mentioned template generating method according to the present invention, computes correlation between the extracted feature component and a template generated by the above-mentioned template generating method according to the present invention, detects a parameter corresponding to the template in the area for detection based on the results of the correlation computation, and detects the position of the object or a predetermined area on the object based on the position of the pattern corresponding to the template detected.

Further, the template generating program according to the present invention is a program using a computer to generate a template used for template matching with a photoelectric conversion signal, which makes the computer realize a function of extracting from a photoelectric conversion signal obtained from an object a predetermined feature component maintaining a predetermined state without being affected by at least one or both of optical conditions at the time of obtaining the photoelectric conversion signal and process conditions given to the object from which the photoelectric conversion signal is obtained and a function of determining a template based on the extracted feature component.

Further, another template generating method according to the present invention is a method of generating a template used when obtaining an image of an object and detecting a desired pattern on the object, including a first step of inputting pattern data corresponding to the desired pattern (step S301), a second step of generating a model of the pattern formed on the object based on pattern data input at the first step (step S302), a third step of virtually calculating a plurality of virtual models corresponding to pattern signals obtained when obtaining an image of the model of the pattern generated at the second step while changing the imaging conditions (step S303), and a fourth step of determining the template based on the plurality of virtual models calculated at the third step (step S304)(see FIG. 17).

According to the template generating method of this configuration, for pattern data corresponding to a desired pattern input by a user etc. at the first step, a plurality of virtual models corresponding to the pattern signals obtained when obtaining the image of this are calculated while changing the imaging conditions at the third step. Further, for example a desired selection rule is applied to these virtual models to determine the template. Therefore, it is possible to generate templates corresponding to various imaging conditions. Further, at this time, at the second step, the input pattern data is converted to a model so as to enable it to be suitably handled as a mark formed on a wafer or to enable it to be suitably handled as data for calculation of virtual models. Therefore, it is possible to input data according to a desired pattern set as a template from any input means.

Further, another template generating method according to the present invention is a method of generating a template used when obtaining an image of an object through a detection optical system and detecting a desired pattern on the object, including a first step of obtaining an image of the desired pattern on the object while changing the imaging conditions (step S401), a second step of setting signal information corresponding to the desired pattern obtained for each of the imaging conditions as a candidate model of the template (step S402), and a third step of averaging the plurality of candidate models set at the second step and using the averaged candidate model as the template (step S403) (see FIG. 22).

Further, another template generating method according to the present invention is a method of generating a template used when obtaining an image of an object and detecting a desired pattern on the object, including a first step of obtaining an image of the desired pattern on the object while changing the imaging conditions (step S401), a second step of setting signal information corresponding to the desired pattern obtained for each of the imaging conditions as a candidate model of the template (step S402), and a third step of calculating correlation among the plurality of candidate models set at the second step and determining the candidate model used from the plurality of candidate models as the template based on the results of correlation calculated (step S403) (see FIG. 22).

Further, another pattern detecting method according to the present invention uses a template generated using the above-mentioned template generating method according to the present invention for template matching with a signal obtained by imaging of the object. Further, another position detecting method according to the present invention uses the above-mentioned pattern detecting method according to the present invention to detect position information of the desired pattern formed on the object.

Further, an exposure method according to the present invention detects the positions of one, a plurality of, or all of a predetermined area of a mask (reticle) on which a pattern for transfer is formed, a substrate for exposure, a predetermined area of the reticle, and a predetermined area of the substrate by the above-mentioned position detecting method according to the present invention, positions the mask and the substrate relative to each other based on the detected positions, exposes the positioned substrate, and transfers the pattern of the mask on to the substrate. Further, the device manufacturing method according to the present invention is a device manufacturing method including a step of exposing the device pattern on the substrate using the above-mentioned exposure method according to the present invention.

Further, a template generating apparatus according to the present invention is an apparatus for generating a template used when obtaining an image of an object and detecting a desired pattern on that object, having an input means for inputting pattern data corresponding to the desired pattern, a model generating means for generating a model of the pattern formed on the object based on the input pattern data, a virtual model calculating means for virtually calculating a plurality of virtual models corresponding to the pattern signals obtained when obtaining an image of the model of the pattern generated while changing the imaging conditions, and a template determining means for determining the template based on the calculated plurality of virtual models.

Further, another template generating apparatus according to the present invention is an apparatus for generating a template used when obtaining an image on an object and detecting a desired pattern on the object, having an imaging means for obtaining an image of the desired pattern on the object while changing the imaging conditions, a candidate model setting means for setting signal information corresponding to the desired pattern obtained for each of the imaging conditions as a candidate model of the template, and a template determining means for averaging the plurality of candidate models set at the second step and using the averaged candidate model as the template.

Further, another template generating apparatus according to the present invention is an apparatus for obtaining an image on an object and generating a template used when detecting a desired pattern on the object, having an imaging means for obtaining an image of the desired pattern on the object while changing the imaging conditions, a candidate model setting means for setting signal information corresponding to the desired pattern obtained for each of the imaging conditions as a candidate model of the template, and a template determining means for calculating a correlation among the plurality of candidate models set and determining a candidate model used as the template from the plurality of candidate models based on the calculated correlation.

Further, the position detecting apparatus according to the present invention has a pattern detecting means for using the above-mentioned template generating apparatus according to the present invention and a template generated by the template generating apparatus for template matching with a signal obtained by obtaining an image of the object to detect a pattern on the object and a position detecting means for detecting a position of the pattern formed on the object based on the pattern detection results.

Further, the exposure apparatus according to the present invention is an exposure apparatus for exposing a substrate by a pattern formed on a mask, having the above-mentioned position detecting apparatus or detecting position information of at least one of the mask and the substrate, a positioning means for relatively positioning the mask and the substrate based on the detected position information, and an exposing mean for exposing the positioned substrate by the pattern of the mask.

Further, another template generating program according to the present invention is a program for generating a template used when obtaining an image of an object and detecting a desired pattern on the object, which makes the computer realize a function of inputting pattern data corresponding to the desired pattern, a function of generating a model of the pattern formed on the object based on the input pattern data, a function of virtually calculating a plurality of virtual models corresponding to the pattern signals obtained when obtaining an image of the model of the pattern generated while changing the imaging conditions, and a function of determining the template based on the calculated plurality of virtual models.

Further, another template generating program according to the present invention is a program for generating a template used when obtaining an image on an object and detecting a desired pattern on the object, which makes the computer realize a function of obtaining an image of the desired pattern on the object while changing the imaging conditions, a function of setting signal information corresponding to the desired pattern obtained for each of the imaging conditions as a candidate model of the template, and a function of averaging the plurality of candidate models set and using the averaged candidate model as the template.

Further, another template generating program according to the present invention is a program for obtaining an image on an object and generating a template used when detecting a desired pattern on the object, which makes the computer realize a function of obtaining an image of the desired pattern on the object while changing the imaging conditions, a function of setting signal information corresponding to the desired pattern obtained for each of the imaging conditions as a candidate model of the template, and a function of calculating a correlation among the plurality of candidate models set and determining a candidate model used as the template from the plurality of candidate models based on the calculated correlation.

Note that in this section, components are described with notations of corresponding components shown in the attached drawings, but these are just for facilitating understanding and are not shown to limit the means according to the present invention to the later explained embodiments explained with reference to the attached figures.

According to the present invention, there are provided a template generating method, template generating apparatus, and template generating program for generating a template not changing due to deformation of the of the image of the mark (photoelectric conversion signal) due to differences in optical conditions, process conditions, etc., in other words, a template handling such deformation. Further, it is possible to provide a template generating method, template generating apparatus, and template generating program enabling such a template to be easily generated from various input sources. Further, it is possible to provide a pattern detecting method able to suitably detect a pattern for detection set by any method while absorbing deformation of the pattern (mark) using a template not changing due to deformation of the of the image of the mark (photoelectric conversion signal) due to differences in optical conditions, process conditions, etc.

Further, it is possible to provide a position detecting method and position detecting apparatus enabling a pattern for detection set by any method to be detected using a template not changing due to deformation of the image of a mark (photoelectric conversion signal) due to differences in optical conditions or process conditions etc. and thereby enabling suitable detection of the position of the pattern in accordance with the deformation of the pattern. Further, it is possible to provide an exposure method and exposure apparatus enabling the position of a pattern for detection set by any method to be detected using a template not changing due to deformation of the image of a mark (photoelectric conversion signal) due to differences in optical conditions or process conditions etc., enabling the exposure position of the substrate etc. to be detected, and enabling suitable exposure at a desired position of the substrate etc. Further, it is possible to provide a device manufacturing method enabling a pattern for detection set by any method to be detected using a template not changing due to deformation of the image of a mark (photoelectric conversion signal) due to differences in optical conditions or process conditions etc., enabling suitable exposure at a desired position of the substrate etc., and thereby enabling suitable manufacture of an electronic device.

### BRIEF DESCRIPTION OF THE DRAWINGS

FIG. 1 is a view of the configuration of an exposure apparatus of a first embodiment of the present invention.

FIG. 2 is a view of the distribution of light information from a mark on a wafer at a pupil plane of a TTL type alignment system of the exposure apparatus shown in FIG. 1.

FIG. 3 is a view of a light receiving surface of a light receiving element of a TTL type alignment system of the exposure apparatus shown in FIG. 1.

FIG. 4 is a cross-sectional view of an indicator board of an off-axis type alignment optical system of the exposure apparatus shown in FIG. 1.

FIG. 5 is a view of the configuration of an FIA processing unit of an off-axis type alignment optical system of the exposure apparatus shown in FIG. 1.

FIG. 6 is a view for explaining symmetry as a feature component used for the template matching of a mark in the exposure apparatus shown in FIG. 1.

FIG. 7A is a view for explaining a search window for detecting symmetry used in the template matching of a mark in the exposure apparatus shown in FIG. 1, while FIG. 7B is a view of the results of computation of correlation using a search window.

FIG. 8A and FIG. 8B are views for explaining the processing for detection of symmetry for a mark of a circular ring pattern.

FIG. 9A, FIG. 9B, and FIG. 9C are views for explaining that space parts may also serve as feature points of symmetry.

FIG. 10 is a flow chart showing the template generating method.

FIG. 11 is a view for explaining that templates for marks with different line widths become the same.

FIG. 12 is a flow chart showing mark detection performed by an FI A processing unit of the off-axis type alignment optical system of the exposure apparatus shown in FIG. 1.

FIG. 13A and FIG. 13B are first views for explaining feature extraction of the mark detection shown in FIG. 12.

FIG. 14A and FIG. 14B are second views for explaining feature extraction of the mark detection shown in FIG. 12.

FIG. 15 is a view of the configuration of an FIA processing unit of an off-axis type alignment optical system of the exposure apparatus shown in FIG. 1 according to a second embodiment of the present invention,

FIG. 16 is a view for explaining alignment mark detection in the FIA processing unit shown in FIG. 15.

FIG. 17 is a flow chart showing a template generating method using an optical image deformation simulator according to a second embodiment of the present invention.

FIG. 18A, FIG. 18B, and FIG. 18C are views for explaining the modeling of input data in the template generating method shown in FIG. 17.

FIG. 19 is a view for explaining virtual model generation in the template generating method shown in FIG. 17.

FIG. 20 is a view for explaining average pattern generation and and weighted average pattern generation in the template determination the template generating method shown in FIG. 17.

FIG. 21 is a view explaining the template determination using correlation among virtual models in the template determination in the template generating method shown in FIG. 17.

FIG. 22 is a flow chart showing the template generating method using an actually measured image according to a second embodiment of the present invention.

FIG. 23 is a flow chart showing mark detection by an FIA processing unit of an off-axis type alignment optical system of the exposure apparatus shown in FIG. 1 according to a second embodiment of the present invention.

FIG. 24 is a flow chart for explaining a device manufacturing method according to the present invention.

FIG. 25 is a view of the configuration of a general mark.

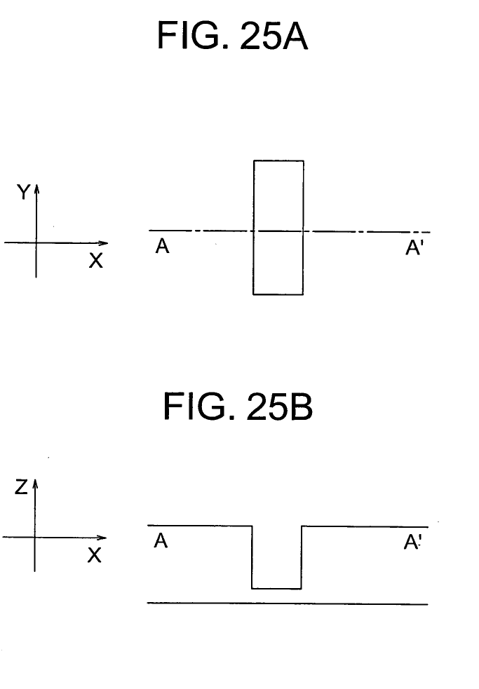

FIG. 26 is a view of the state of change of an observed image of a mark due to changes in optical conditions and process conditions.

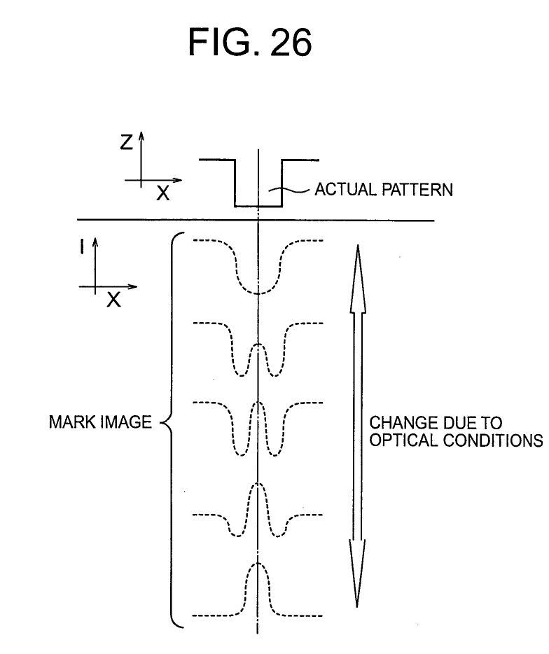

### DESCRIPTION OF THE PREFERRED EMBODIMENTS

### First Embodiment

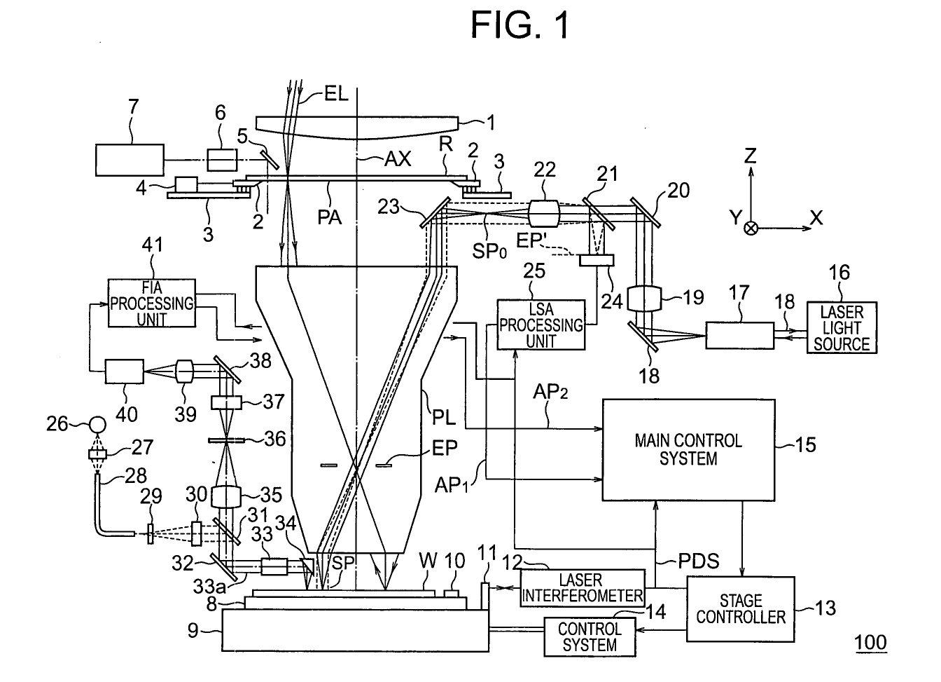

A first embodiment of the present invention will be explained with reference to FIG. 1 to FIG. 14B. In the first embodiment, the explanation will be given of using a feature not changing even if the image of a mark (photoelectric conversion signal) deforms due to a difference in the optical conditions or process conditions for generation of a template, pattern detection using that template, position detection based on the pattern detection results, and exposure based on the position detection results. Specifically, in the present embodiment, the explanation will be given of an exposure apparatus having an off-axis type alignment optical system for detecting an alignment mark of a wafer by image processing using a template generated by the template generating method according to the present invention and a pattern detecting method and position detecting method according to the present invention.

First, the configuration of the exposure apparatus will be explained with reference to FIG. 1 to FIG. 4. FIG. 1 is a view showing the schematic configuration of the exposure apparatus 100 of the present embodiment. Note that in the following explanation, the XYZ Cartesian coordinate system shown in FIG. 1 is set. In the following explanation, this XYZ Cartesian coordinate system will be referred to for explaining the positional relationship of the members. The XYZ Cartesian coordinate system is set so that the X-axis and the Z-axis become parallel to the paper surface, while the Y-axis is set to a direction perpendicular to the paper surface. In the XYZ coordinate system in the figures, actually the XY plane is set to a plane parallel to the horizontal plane, while the Z-axis is set to the vertically upward direction.

As shown in FIG. 1, exposure light EL emitted from a not shown illumination optical system is focused via a condenser lens 1 to a pattern area PA formed on a reticle R by a uniform luminance distribution. As the exposure light EL, for example g-rays (436 nm) or i-rays (365 nm) or light emitted from a KrF excimer laser (248 nm), ArF excimer laser (193 nm), or F2 laser (157 nm) is used.

The reticle R is held on a reticle stage 2, while the reticle stage 2 is supported so as to be able to move and finely turn in a two-dimensional plane on a base 3. A main control system 15 for controlling the operation of the apparatus as a whole controls the operation of the reticle stage 2 through a drive apparatus 4 on the base 3. This reticle R is positioned with respect to the optical axis AX of a projection lens PL by a not shown reticle alignment mark formed at its periphery being detected by a reticle alignment system comprised of a mirror 5, object lens 6, and mark detection system 7.

Exposure light EL passing through the pattern area PA of the reticle R for example strikes a two-sided (or one-sided) telecentric projection lens PL and is projected on an individual shot area on the wafer (substrate) W. The projection lens PL is corrected for aberration best for the wavelength of the exposure light EL. Under that wavelength, the reticle R and the wafer W are conjugate. Further, the illumination light EL is Koehler illumination and is focused as a light source image at the center in the pupil EP of the projection lens PL. Note that the projection lens PL has a plurality of lenses and other optical elements. The material of the optical elements is selected in accordance with the wavelength of the exposure light EL from quartz, fluorite, or another optical material.

The wafer W is placed via a wafer holder 8 on a wafer stage 9. On the wafer holder 8, a fiducial mark 10 used for baseline measurement etc. is provided. The wafer stage 9 has an XY stage for positioning a wafer W two-dimensionally in a plane vertical to the optical axis AX of the projection lens PL, a Z-stage for positioning the wafer W in a direction parallel to the optical axis AX of the projection lens PL (Z-direction), a stage for finely turning the wafer W, a stage for changing the angle with respect to the Z-axis and adjusting the tilt of the wafer W with respect to the XY plane, etc.

At one end on the top surface of the wafer stage 9, an L-shaped moving mirror 11 is attached. At a position facing the mirror surface of the moving mirror 11, a laser interferometer 12 is arranged. While shown simplified in FIG. 1, the moving mirror 11 is comprised of a flat mirror having a reflection surface vertical to the X-axis and a flat mirror having a reflection surface vertical to the Y-axis. Further, the laser interferometer 12 is comprised of two X-axis laser interferometers emitting laser beams along an X-axis to the moving mirror 11 and a Y-axis laser interferometer emitting a laser beam along a Y-axis to the moving mirror 11. One of the X-axis laser interferometers and the Y-axis laser interferometer are used to measure the X-coordinate and Y-coordinate of the wafer stage 9. Further, the difference in measurement values of the two X-axis laser interferometers is used to measure the rotational angle of the wafer stage 9 in the XY plane.

A position detection signal PDS showing the X-coordinate, Y-coordinate, and rotational angle measured by the laser interferometer 12 is supplied to a stage controller 13. The stage controller 13, under the control of the main control system 15, controls the position of the wafer stage 9 in accordance with this position detection signal PSD via a drive system 14. Further, the position detection signal PDS is output to the main control system 15. The main control system 15 monitors the supplied position detection signal PDS and outputs a control signal controlling the position of the wafer stage 9 to the stage controller 13. Further, the position detection signal PDS output from the laser interferometer 12 is output to a later explained laser step alignment (LSA) processing unit 25. Note that a detailed explanation of the main control system 15 will be given later.

Further, the exposure apparatus 100 has a laser light source 16, a beam shaping optical system 17, a mirror 18, a lens system 19, a mirror 20, a beam splitter 21, an object lens 22, a mirror 23, a light receiving element 24, an LSA processing unit 25, and a projection lens PL forming a TTL type alignment optical system. The laser light source 16 is, for example, an He—Ne laser or other light source and emits a laser beam LB of a red light (for example wavelength 632.8 nm) to which the photoresist coated on the wafer W is not sensitive. This laser beam LB passes through the beam shaping optical system 17 including a cylindrical lens etc. and travels via the mirror 18, lens system 19, mirror 20, and beam splitter 21 to strike the object lens 22. The laser beam LB passing through the object lens 22 is reflected at the mirror 23 provided below the reticle R at an inclined direction with respect to the XY plane, strikes the periphery of the field of the projection lens PL parallel to the optical axis AX, passes through the center of the pupil EP of the projection lens PL, and vertically irradiates the wafer W.

The laser beam LB is focused to a slit-shaped slot SP0 in the space in the light path between the object lens 22 and projection lens PL due to the action of the beam shaping optical system 17. The projection lens PL refocuses this spot of light SP0 on the wafer W as a spot of light SP. The mirror 23 is fixed outside from the periphery of the pattern area PA of the reticle R and in the field of the projection lens PL. Therefore, the slit-shaped spot of light SP formed on the wafer W is positioned at the outside of the projected image of the pattern are a PA.

In order to use this spot of light SP to detect a mark on the wafer W, the wafer stage 9 is moved in the XY plane horizontally with respect to the spot of light SP. When the spot of light SP scans the mark, specular reflected light, scattered light, diffracted light, etc. are generated from the mark. The amount of light changes depending on the relative positions of the mark and the spot of light SP. This optical information proceeds backward along the light path of the laser beam LB, travels via the projection lens PL, mirror 23, object lens 22, and beam splitter 21, and reaches the light receiving element 24. The light receiving surface of the light receiving element 24 is arranged at a pupil plane EP′ substantially conjugate with the pupil EP of the projection lens PL, has an area insensitive to the specular reflected light from the mark, and receives only the scattered light or diffracted light.

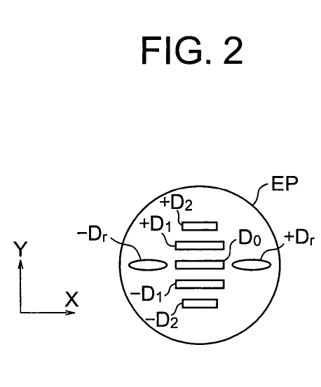

FIG. 2 is a view of the distribution of optical information from the mark on the wafer W on the pupil EP (or pupil plane EP′). Above and below (Y-axial direction) the specular reflected light DO extending in a slit shape at the center of the pupil EP in the X-axial direction, positive primary diffracted light +D1 and secondary diffracted light +D2 and negative primary diffracted light −D1 and secondary diffracted light −D2 are arranged. At the right and left (X-axial direction) of the specular reflected light D0, scattered light ±Dr is positioned from the mark edge. This is described in detail in for example Japanese Patent Publication (A) No. 61-128106, so a detailed explanation will be omitted, but the diffracted lights ±D1 and ±D2 are generated only when the mark is a diffraction grating mark.

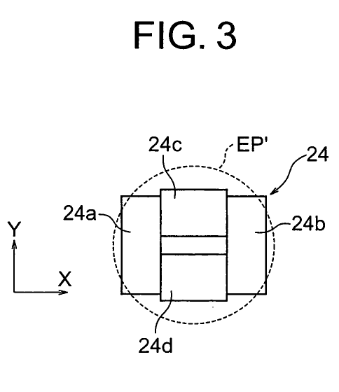

To receive the optical information from the mark having the distribution shown in FIG. 2, the light receiving element 24, as shown in FIG. 3, is divided into four independent light receiving surfaces 24a, 24b, 24c, 24d in the pupil plane EP′ and is arranged so that the light receiving surfaces 24a and 24b receive the scattered light ±Dr, while the light receiving surfaces 24c and 24d receive the diffracted lights ±D1 and ±D2. FIG. 3 is a view of the light receiving surface of the light receiving element 24. Note that the numerical aperture (NA) of the projection lens PL at the wafer W side is large. When tertiary diffracted light generated from the diffraction grating mark also passes through the pupil EP, the light receiving surfaces 24c and 24d should be made sizes to also receive this tertiary light.

The photoelectric signals from the light receiving element 24 are input together with the position detection signal PDS output from the laser interferometer 12 to the LSA processing unit 25 where mark position information AP1 is prepared. The LSA processing unit 25 samples and stores the photoelectric signal waveforms from the light receiving element 24 when the spot of light SP scans the wafer mark based on the position detection signal PDS, analyzes the waveforms, and outputs mark position information AP1 as the coordinate position of the wafer stage 9 when the center of the mark is in register with the center of the spot of light SP.

Note that in the exposure apparatus shown in FIG. 1, only one TTL type alignment system (16, 17, 18, 19, 20, 21, 22, 23, 24) is shown, but another system is provided in a direction perpendicular to the paper surface (Y-axial direction). A similar spot of light is formed in the projected image plane. The extensions of these two spots of light in the longitudinal direction are directed toward the optical axis AX. Further, the solid line shown in the light path of the TTL type alignment optical system in FIG. 1 shows the imaging relationship with the wafer W, while the broken line shows the conjugate relationship with the pupil EP.

Further, the exposure apparatus 100 is provided with an off-axis type alignment optical system according to the present invention (below, called an “alignment sensor”) at the side of the projection optical system PL. This alignment sensor is an FIA (field image alignment) type alignment sensor using a template generated by the template generating method of the present invention to detect an alignment mark and detecting its position by the pattern detecting method and position detecting method of the present invention.

Note that in this embodiment, the explanation will be given assuming an alignment mark (mark pattern) on a wafer as the pattern for detection (pattern for template matching and pattern for generating template data), but the pattern for detection is not limited to a mark pattern. It is also possible to use part of the device pattern on the wafer (circuit pattern), part of a straight line, or various other patterns formed on the wafer as the pattern for detection.

This alignment sensor has a halogen lamp 26 for emitting illumination light for illuminating the wafer W, a condenser lens 27 for condensing the illumination light emitted from the halogen lamp 26 at one end of an optical fiber 28, and an optical fiber 28 for guiding the illumination light. The light source of the illumination light is made the halogen lamp 26 because the wavelength band of the illumination light emitted from the halogen lamp 26 is 500 to 800 nm. This is a wavelength band to which the photoresist coated on the top surface of the wafer W is not sensitive. The wavelength band is broad and therefore it is possible to reduce the effects of the wavelength features of the reflectance at the surface of the wafer W.

The illumination light emitted from the optical fiber 28 passes through a filter 29 cutting the sensitive wavelength (short wavelength) region and infrared wavelength region of the photoresist coated on the wafer W and travels via the lens system 30 to a half mirror 31. The illumination light reflected by the half mirror 31 is reflected by the mirror 32 substantially parallel to the X-axial direction, then strikes the object lens 33 and further is reflected at a prism (mirror) 34 fixed at the periphery of the bottom of the barrel of the projection lens PL so as not to block the field of the projection lens L and illuminates the wafer W vertically.

Note that while the illustration is omitted in FIG. 1, a suitable illumination field aperture is provided in the light path from the emission end of the optical fiber 28 to the object lens 33 at a position in relation to the object lens 33 conjugate with the wafer W. Further, the object lens 33 is provided in a telecentric system. At the plane 33a of the opening aperture (same as pupil), an image of the emission end of the optical fiber 28 is formed and Koehler illumination performed. The optical axis of the object lens 33 is set to be vertical on the wafer W so as to prevent deviation of the mark position due to the tilting of the optical axis at the time of mark detection.

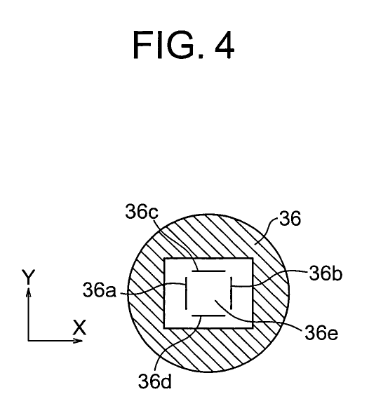

The light reflected from the wafer W travels via the prism 34, object lens 33, mirror 32, and half mirror 31 and is focused by the lens system 35 on an indicator board 36. This indicator board 36 is arranged by the object lens 33 and lens system 35 conjugate with the wafer W and, as shown in FIG. 4, has straight indicator marks 36a, 36b, 36c, and 36d extending in the X-axial direction and the Y-axial direction in a rectangular transparent window. FIG. 4 is a cross-sectional view of the indicator board 36. Therefore, the image of the mark on the wafer W is formed in the transparent window 36e of the indicator board 36. The image of the mark of the wafer W and the indicator marks 36a, 36b, 36c, and 36d are formed via the relay systems 37, 39 and mirror 38 on an image sensor 40.

The image sensor (light receiving element, light receiving means) 40 converts the optical image striking the imaging plane to obtain a photoelectric conversion signal (image signal, image information, pattern signal, input signal). For example, a two-dimensional CCD is used.

Note that in this embodiment, the explanation will be given assuming use of a one-dimensional projection signal obtained by accumulating (projecting) the signal from a two-dimensional CCD in the nonmeasurement direction for position measurement, but the present invention is not limited to this. It is also possible to process a two-dimensional signal by two-dimensional image processing for position measurement. Further, it is also possible to use an apparatus enabling three-dimensional image processing and measure the position by a three-dimensional image signal. Further, the present invention may also be applied to developing a photoelectric conversion signal obtained by a light receiving element (CCD) into n dimensions (n being an integer of 1 or more) (for example, developed to an n-dimensional cosine component signal etc.) and using that n-dimensional signal for position measurement. Note that below, when referring to an “image”, “image signal”, “pattern signal”, etc., this shall include not only a two-dimensional image signal, but also the above-mentioned n-dimensional signal (n-dimensional image signal, signal developed from the image signal, etc.)

The image signal (input signal) output from the image sensor 40 is input to the FIA processing unit 41 together with the position detection signal PDS from the laser interferometer 12. The FIA processing unit 41 finds the deviation of the mark image with respect to the indicator marks 36a to 36d from the input image signal (input signal) and outputs information AP2 relating to the mark center detection position of the wafer stage 9 when the image of the mark formed on the wafer W is accurately positioned at the center of the indicator marks 36a to 36d from the stopped position of the wafer stage 9 shown by the position detection signal PDS.

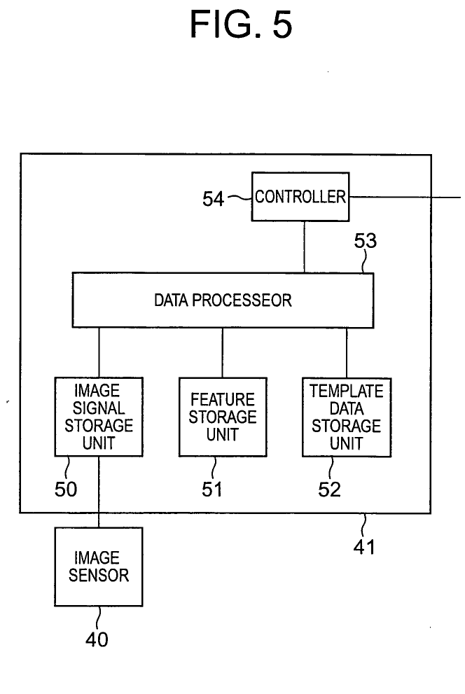

Next, the FIA processing unit 41 will be explained in detail with reference to FIG. 5 to FIG. 14B. FIG. 5 is a block diagram showing the internal configuration of the FIA processing unit 41. As shown in FIG. 5, the FIA processing unit 41 has an image signal storage unit 50 for storing an image signal (input signal) input from the image sensor 40, a feature storage unit 51 for storing a feature extracted from the image signal stored in the image signal storage unit 50, a template data storage unit 52 for storing reference feature information (template data), a data processor 53, and a controller 54 for controlling the operation of the FIA processing unit 41 as a whole. The data processor 53 performs processing such as extraction of features from an image signal, matching between an extracted feature and a template, detection of the presence of a mark based on the results of matching, and acquisition of position information when a mark is included.

First, the content of the processing in the FIA processing unit 41 of this configuration will be explained. The FIA processing unit 41 detects a mark by the image input via the image sensor 40 by, first, judging if the image signal includes an image of the mark and, when it is included, finding at what position in the field it is. Due to this, for the first time, information relating to the mark center position of the wafer stage 9 at the time when the image of the mark formed on the wafer W is accurately positioned at the center of the indicator marks 36a to 36d can be obtained.

The FIA processing unit 41 judges if the image signal (input signal) includes the desired mark and detects its position not by comparing the waveform signal of the image signal (baseband signal) with the template, but by matching a predetermined feature obtained from the image signal with reference feature data (template data) prepared in advance in the feature space. As the feature used, a feature resistant to the effect of the optical conditions and process conditions is suitable. Any such feature can be used. Note that the “optical conditions” referred to here are specifically conditions relating to the imaging lens performance (aberration, numerical aperture, etc.), luminance, and focus position of each imaging device or imaging operation, in particular here, conditions which vary among imaging devices or change for each imaging operation. Further, the “process conditions” mean step differences a rising after for example CMP or other processing, variations in thickness of the resist, and other varying factors of the mark image (waveform signal) due to the mark itself.

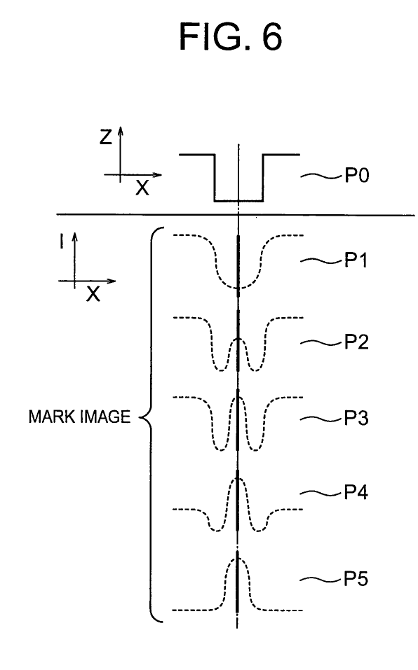

In the present embodiment, the symmetry in the waveform signal of the mark image is used as this feature. As shown in FIG. 6, even if the original mark pattern P0 is for example a line pattern of a certain width, for example if the focus state at the time of imaging changes, as shown in the figure, the mark waveform signal will change (P1 to P5). However, if the line pattern P0 is a pattern having symmetry, even if the mark image obtained by the optical conditions or process conditions changes such as with the waveform signals P1 to P5, the position of the center of symmetry (bold line part in FIG. 6) will not change. Further, the symmetry of the signal waveform at the two sides of the center of symmetry is also maintained. Therefore, symmetry can be said to be a feature resistant to the effect of changes in focus and other optical conditions and changes in resist film thickness or other process conditions and is suitable for use as a feature for mark detection.

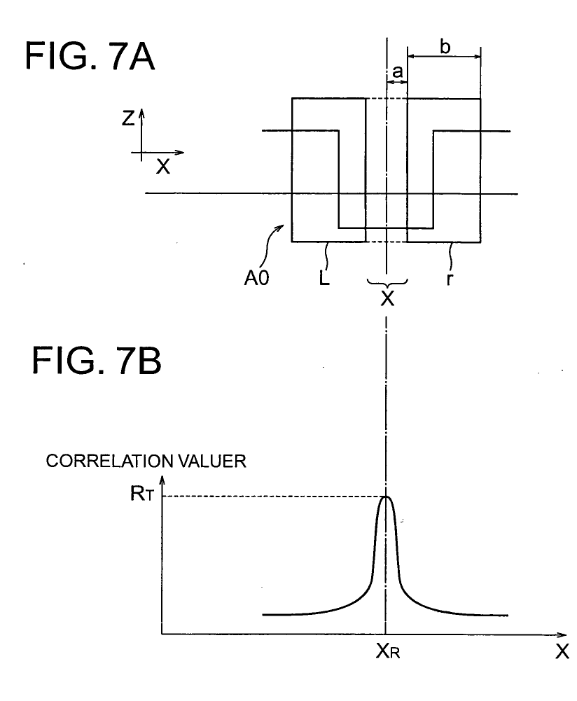

The feature value of symmetry is detected by finding the correlation of the image signal between predetermined areas at the two sides of the center of symmetry (symmetric areas). In the present embodiment, the reversed autocorrelation function (inverted autocorrelation function) defined by equation (1) or equation (2) is applied to predetermined areas L and r in the linear space A0 shown in FIG. 7A (two-dimensional space of XZ or XI). The obtained correlation value is made the feature value in that direction in the center of symmetry of that linear space.

In equation (1) and equation (2), R is the reversed autocorrelation value (inverted autocorrelation value), while f(X) is the luminance value of the pixel X. Further, N is the total number of data used for calculation. When using uneven dispersion for calculation, N−1 is used. Further, ave1(X) is the average value of the signal included in the area L, while ave2(X) is the average value of the signal included in the area r. Further, a and b are values defining the scope of the search linear space (search window) shown in FIG. 7A. Note that the “search window” is a virtual window used for computation. Note that the correlation value R found by equation (1) is stripped of the amplitude and as a result is a value not changing with respect to the amplitude. Further, the correlation value R found by equation (2) considers the amplitude, that is, becomes a value reflecting the value of the amplitude. Which equation to use to find the correlation value is suitably determined in accordance with the situation desired to be measured etc.

Further, by setting the value a defining the scope of the search window to a value of more than 0, as shown in FIG. 7A, it is possible to set an area X (insensitive area X) not covered by the calculation of the autocorrelation. As a result, a pattern with a line width smaller than 2×a can be ignored, and noise etc. can be easily removed. Note that for the scope of the search window for detecting symmetry, by detecting the SN ratio and adding processing regarding only an area with a large SN ratio as a mark area, it becomes possible to extract the feature of only the mark area.

To copy the mark image of a desired shape to a feature space of symmetry, first, based on a function defining the mark, a shape defining that mark is copied to a function space where the measurement covers a linear space. As a result, at each position of the shape defining the mark, a linear space defined as shown in FIG. 7A is defined for each predetermined direction. Equation (1) or equation (2) is applied to this space to find the correlation value, that is, the feature value. Due to this, at each position corresponding to the shape defining the mark, a feature including the correlation value R showing the direction of symmetry and the degree of symmetry is detected.

Each mark is defined as a set of such features in this feature space, in other words, as a set of data of the direction of symmetry and correlation value (degree of symmetry) for the number of features (number of positions where features are detected) (FIG. 7B). FIG. 7B, in other words, shows the results when moving the search window in the X-direction and using equation (1) or equation (2) to compute the correlation. The thus found correlation value waveform (FIG. 7B) is used as a template in this embodiment. Further, when using this template waveform (waveform of FIG. 7B) for template matching, a waveform similar to FIG. 7B is found for each mark to be detected using equation (1) or equation (2) and template matching is performed between the waveform of each mark found and the template waveform. Further, processing is performed to extract a mark with a high degree of match with the template waveform.

Note that it is also possible to use the peak correlation value RT itself detected by equation (1) or equation (2) as a feature (template information). In this case, the mark image where the inverted autocorrelation value R becomes RT when using the peak correlation value RT as a template and finding the inverted autocorrelation for the mark image to be detected becomes the mark image extracted by the template matching.

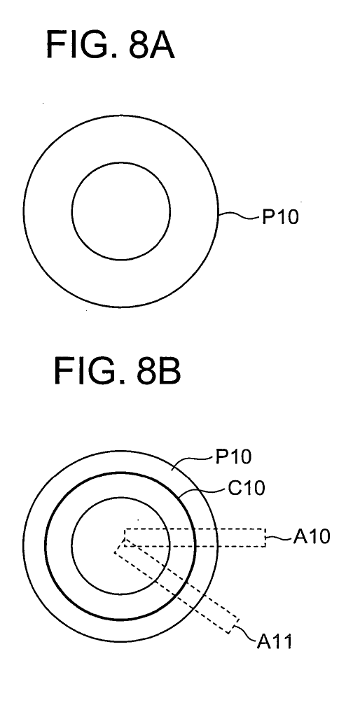

The mark to be detected is not limited to a line or a mark of a shape with clear symmetry at first glance. It may be any shape able to be expressed as a function. For example, the mark to be detected may also be a circular ring shaped pattern P10 such as shown in FIG. 8A. When detecting such a mark, based on the function G(z) defining this pattern P10, the linear calculation areas A10, A11 . . . in the radial direction such as shown in FIG. 8B are successively set along the circumference. Next, the reversed autocorrelation is calculated for each of the plurality of calculation areas set in the same way as in equation (1) or equation (2). As a result, a circular ring pattern C10 connecting the centers of symmetry of the linear areas as shown in FIG. 8B and the feature of the circular ring pattern P10 including information on the direction of symmetry and feature value (correlation value) at several positions on this pattern C10 are found.

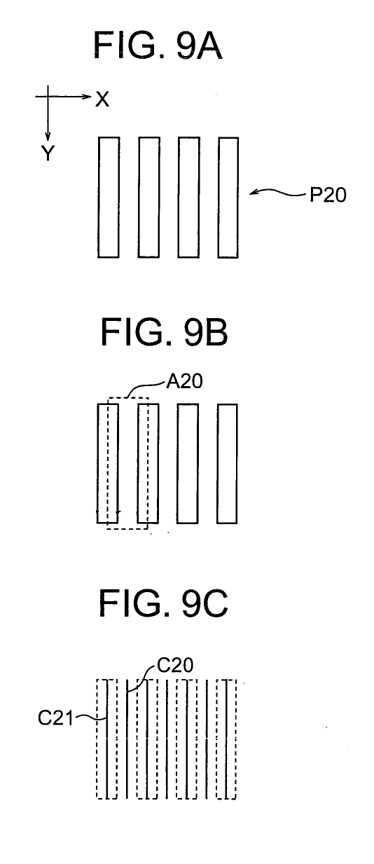

Further, the position of the center of symmetry is important information where the direction of symmetry and the feature value are linked, but setting at a line part is not a condition. For setting symmetry, that is, for setting a mark, a space part may also be utilized. F or example, in the case of the line and space mark P11 shown in FIG. 9A, by detecting the area A20 shown in FIG. 9B as a mark, it is possible to find a pattern having symmetry even in the space part between lines. By considering such a mark as well, as shown in FIG. 9C, it is possible to extract the feature value both for the center of symmetry C21 of a line part and also for the center of symmetry C20 of a space part. As a result, it is possible to extract more information required for wafer positioning and possible to improve the measurement precision.

The FIA processing unit 41 matches a feature extracted from the obtained image signal and template data stored in advance in the template data storage unit 52 in the feature space having such symmetry as a feature to detect the presence of the desired mark.

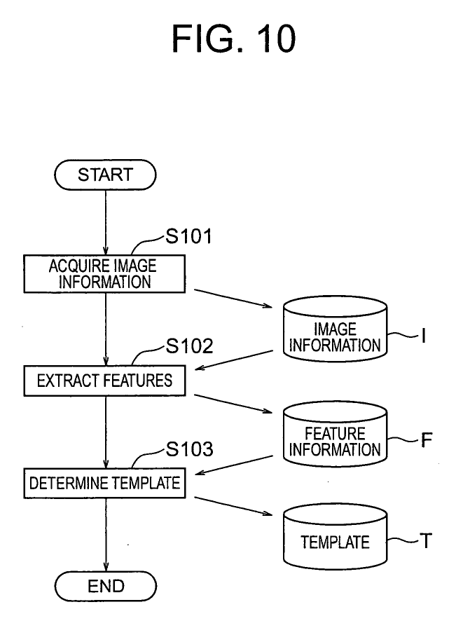

Next, the method of generating template data stored in advance in the template data storage unit 52 will be explained. FIG. 10 is a flow chart of this template generating processing. Note that the processing for generating template data explained below is suitably performed by having an external computer apparatus etc. separate from the exposure apparatus 100 run the program for processing explained below as shown in the flow chart off FIG. 10. However, the invention is not limited to this. This may also be performed in the exposure apparatus 100. Specifically, for example, it may also be performed in the data processor 53 in the FIA processing unit 41. Note that here, the case of processing a mark of a shape complicated to a certain extent where the shape of the mark is defined by a function as explained above will be explained.

First, an image signal I of a reference mark for detection is obtained (step S101). The image signal of the reference mark may be obtained by generating it from design data of the mark or may be obtained by inputting an image of a for example printed, output, or other mark by a scanner etc. Further, a mark actually formed on the wafer may be obtained by imaging by an alignment sensor of the exposure apparatus 100. However, the resolution, gradation, and other conditions are preferably made the same conditions as the mark actually obtained from the wafer in the alignment sensor of the exposure apparatus 100 at the time of alignment.

When the image signal is obtained, this is scanned for extraction of the feature of symmetry (step S102). That is, first, based on the function of the mark, linear spaces for calculation of the reversed autocorrelation are successively set (in other words, the correlation window is scanned) to find the reversed autocorrelation value shown in equation (1) or equation (2) for each linear space. Further, the information of the direction of the linear space (direction of symmetry) for each set linear space and the information on the obtained autocorrelation value R are stored as feature information F having the center of this linear space as the center of symmetry (specifically, the waveform shown in FIG. 7B).

Further, based on the feature information F, finally the template data stored in the exposure apparatus 100 is determined (step S103). In the usual case, that is, when reading the reference mark with good accuracy and finding the correlation value for the feature point stored as a template from the start, the feature information F extracted at step S102 is stored as it is as template data T. However, for example, when deleting features with low correlation values, when generating a template based on a mark obtained by actually imaging from the wafer, etc., only the effective information is obtained and selected from the obtained feature information F to determine the template data T. Further, when combining the feature information of the feature points and generating a feature value for the mark as a whole etc., processing is performed for generating this information based on the obtained feature information F. Here, such processing is performed in accordance with need to finally determine the template.

Further, the thus generated template data is stored in the template data storage unit 52 of the FIA processing unit 41 of the exposure apparatus 100.

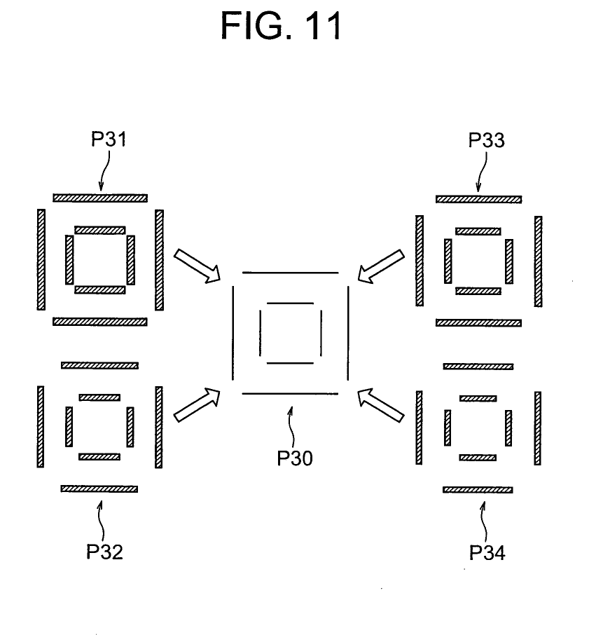

Note that in the feature space of symmetry, as explained above, even if the line width of a pattern differs according to the process conditions or optical conditions make the mark appear different, the position of the center of symmetry can be unambiguously extracted. As a result, as shown in FIG. 11, even with patterns P31 to P34 with line widths originally differing from the design stage, it is sufficient to generate a single template P30 for marks of the same primitive basic structures, that is, geometric structures. Therefore, in the template generating step, it is sufficient to generate a single template for marks of the same basic structure among the marks used. In other words, in the template generating step, a template is generated for each mark with a different basic structure.

Next, the operation of the alignment sensor including the FI A processing unit 41 will be explained focusing on the mark detection operation in the FIA processing unit 41. First, when the operation is started, the main control system 15 drives the wafer stage 9 via the stage controller 13 and drive system 14 so that the mark on the wafer W enters the field of the alignment sensor. When this movement processing ends, the illumination light of the alignment sensor illuminates the wafer W. That is, the illumination light emitted from the halogen lamp 26 is condensed by the condenser lens 27 at one end of the optical fiber 28, enters the optical fiber 28, is propagated through the optical fiber 28, emitted, passes through the filter 29 and travels via the lens system 30 to reach the half mirror 31.

The illumination light reflected by the half mirror 31 is reflected by the mirror 32 substantially horizontally with respect to the X-axial direction, then strikes the object lens 33, is reflected at the prism 34 fixed at the periphery of the bottom of the barrel of the projection lens PL so as not to block the field of the projection lens PL, and vertically illuminates the wafer W. The light reflected from the wafer W travels via the prism 34, object lens 33, mirror 32, and half mirror 31 and is focused by the lens system 35 on the indicator board 36. The image of the mark of the wafer W and the indicator marks 36a, 36b, 36c, and 36d are formed on the image sensor 40 via the relay systems 37 and 39 and mirror 38. The image data formed at the image sensor 40 is fetched into the FIA processing unit 41. This detects the position of the mark and outputs information AP2 relating to the mark center detection position at the wafer stage 9 when the image of the mark formed on the wafer W is accurately positioned at the center of the indicator marks 36a to 36d.

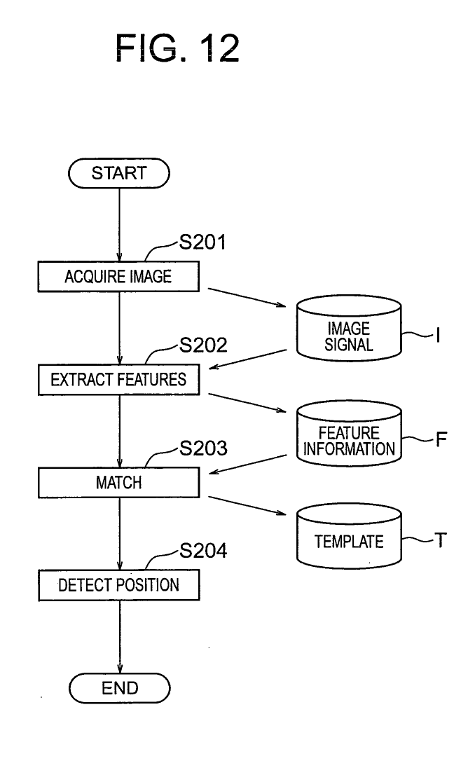

The operation in the FIA processing unit 41 for detecting the position of a mark from the image information will be explained in detail with reference to FIG. 12 to FIG. 14B. First, the image signal storage unit 50 fetches and stores the image signal I of the field image from the image sensor 40 (step S201). When the image signal is stored in the image signal storage unit 50, based on the control signal from the controller 54, the data processor 53 starts the feature extraction (step S202). That is, it scans the image signal input and stored in the image signal storage unit 50 and detects feature points and feature values having symmetry. When detecting a mark with an uncertain position in the field image and sometimes not existing, first the feature of symmetry is extracted for each direction in the linear space across the entire field area.

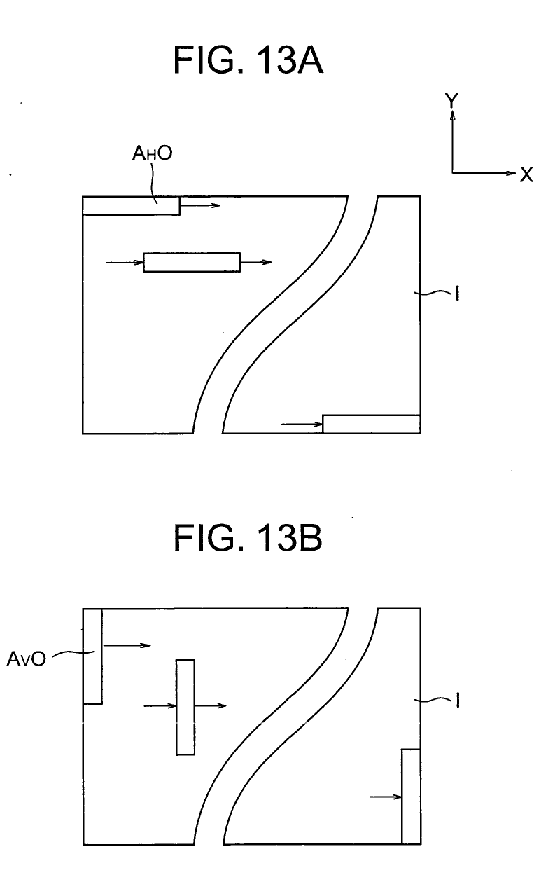

For example, when the image signal I for the entire field such as shown in FIG. 13A is input, this entire region is first scanned by a predetermined linear area AH0 in the X-direction (horizontal direction in figure) and the reversed autocorrelation value is calculated for each area by equation (1) or equation (2). Further, for example, when the correlation value is a predetermined threshold value or more, its position (in this case, the center of symmetry position) is detected as a position having feature of symmetry in that direction (horizontal direction). Further, the correlation value at that time is stored as a feature value.

Note that the method of handling the reversed autocorrelation function detected for each area is not limited to the above embodiment and may be any method. For example, it is also possible not to compare the calculated correlation value with a threshold value to clarify the existence of symmetry, but to register the correlation value as a feature value of the position as it is. If there is almost no symmetry, the correlation value becomes a value close to 0. Depending on the method of matching, even if not specially judging a feature point, there is no effect on the matching. On the other hand, it is also possible to judge only the existence of symmetry and store this as a binary feature value. In this case, the correlation value is used only for judgment of the existence of symmetry. The method of processing of this data may be suitably determined in accordance with the speed of data processing required, method of realization, etc.

The features are extracted for all directions required for detection of a mark. Therefore, after extraction of the feature of symmetry in the X-direction, for example, as shown in FIG. 13B, the feature of symmetry in the Y-direction (vertical direction) is extracted. That is, the image signal I of the field as a whole is scanned by a predetermined linear area AV0 in the Y-direction and the reversed autocorrelation value of equation (1) or equation (2) is calculated for each area. Further, for example when the correlation value is a predetermined threshold value or more, that position is detected as a position having a feature of symmetry in the vertical direction. Further, the correlation value at that time is stored as a feature value.

If the mark is a pattern formed for example by only lines extending in the X-direction and Y-direction, by extracting the features of symmetry in these X-direction and Y-direction, it is possible to suitably perform the next template matching. However, in the case of a mark having an inclined line not parallel to either of the X-axis and Y-axis or a circular ring pattern shown in for example FIG. 8A etc., it is necessary to further detect the symmetries of the different directional components forming the mark. Note that which direction components the features are extracted for depends on which directional component the symmetry of which is used as a feature as the template. That is, it is necessary to extract the feature of symmetry for the same directional component as the template. Therefore, this is controlled by a control signal from the controller 54 based on the template data stored in the template data storage unit 52.

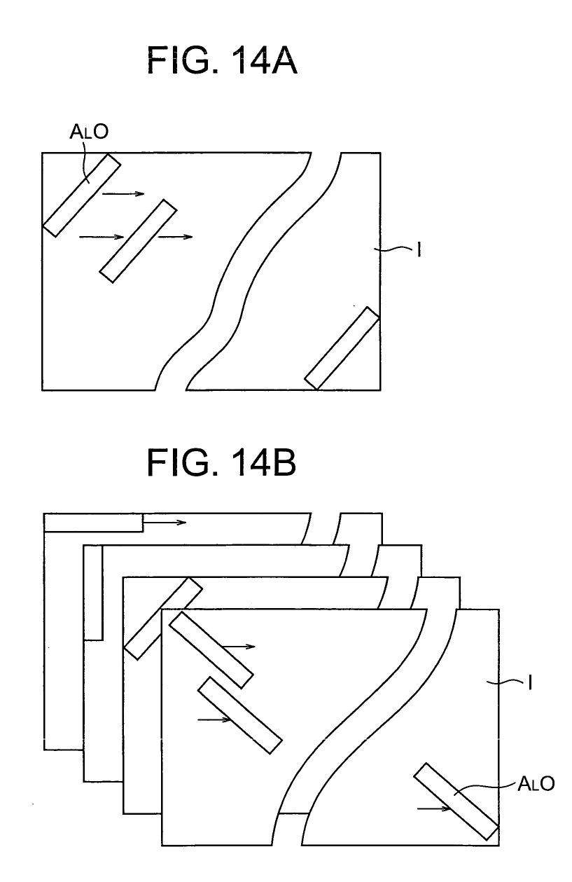

In the present embodiment, after the detection of the symmetry in the X-direction and Y-direction, the feature of symmetry is extracted for the right inclined direction shown in FIG. 14A and the left inclined direction shown at the topmost plane in FIG. 14B. That is, the image signal I of the field as a whole is scanned by each of the predetermined line area AR0 in the right inclined direction and the predetermined linear area AL0 in the left inclined direction and the reversed autocorrelation value of equation (1) or equation (2) is calculated for each area. Further, for example, when the correlation value is a predetermined threshold value or more, the position is detected as a certain position of the feature of symmetry in the right inclined direction or the left inclined direction. Further, the correlation value at this time is stored as the feature value.

As a result of this processing, as shown in FIG. 14B, the feature of symmetry is extracted for each of the four directions for the field image I. Further, the extracted feature values are stored along with the information of the direction of symmetry and position as feature information F in the feature storage unit 51. Note that at this time, the feature storage unit 51 is set with feature values for each of the directional components of the four directions corresponding to the pixel positions of the field image.

After the feature extraction ends, the data processor 53 performs matching with a template stored in the template data storage unit 52 to detect a mark from the field area (step S203). Specifically, the data processor 53 first reads the template data of the mark to be detected from the mark template data storage unit 52. Next, it reads the feature information for the field area as a whole stored in the feature storage unit 51. Next, it successively extracts from the read feature information the information of areas of the same scope as the size of the template data. Further, for each extracted area, it compares the template data and the feature values of the corresponding positions and detects if there is a mark at that position.

The matching is basically performed by checking if the template and feature are the same for each position in the same relative positional relationship with the template. Further, if the feature is the same across the entire region of the template, it is judged that there is a mark at that position. The feature being the same indicates basically that the feature values for the different directions of symmetry are substantially the same at positions corresponding to the obtained feature information and template.

However, various methods may be considered as the specific method of this matching and the method of judging the identity of features. For example, the method may be considered of finding the degrees of correlation, degrees of similarity, or degrees of difference of the feature information of the extracted areas and the template data by a predetermined calculation equation based on the feature values of the corresponding positions and judge that an area with the highest found degree of correlation above a predetermined threshold value includes the mark. In this case, as the calculation equation for finding the degree of similarity, the sum of the differences of the corresponding feature values or the sum of the differences of squares of the feature values may be considered. Further, when a feature value shows only the presence of symmetry at that position, it is possible to successively check only if the existence of symmetry matches in the range of the extracted area and judge the existence of a mark in accordance with the number of matching positions.

Note that the matching between this feature information and template information may be considered to be computation of the degrees of similarity of the feature vectors of the number of dimensions of (number of positions detecting features)×(direction of symmetry detected at the positions). Therefore, the blurring, normalization of the positions of the feature points, normalization of the feature values, and other processing used in ordinary matching may also be freely applied to these feature vectors.

When the matching covering the entire area of the image information of the field area stored in the image signal storage unit 50 results in a mark being detected, the position of the mark is detected based on the position of the extracted area at that time (step S203). Further, the data processor 53 outputs the result of processing indicating fact of the match of the extracted feature information and template, that is, the fact of the mark being detected, to the controller 54. As a result, the controller 54 outputs this as the information AP2 relating to the mark center position to the main control system 15 and ends the series of position detection.

On the other hand, when no mark is detected at step S203, under the control of the main control system 15 of the exposure apparatus 100, the wafer stage 9 is made to move via the stage controller 13 and drive system 14 and the area on the wafer W in the field of the alignment sensor is changed. Further, the image of the field area is again fetched by the FIA processing unit 41 for repeated mark detection.

In the exposure apparatus 100, based on the information AP2 relating to the mark center detection position obtained by this processing, the main control system 15 drives the wafer stage 9 via the stage controller 13 and drive system 14, matches the position at which a pattern formed on the reticle R is projected and the position of the wafer W, and exposes the pattern on the wafer W.

In this way, according to the exposure apparatus of the present embodiment, it is possible to extract from a mark a feature not affected by changes in the mark image due to changes in the optical conditions, changes in the mark due to changes in the process conditions, etc. Further, by generating a template from this feature and performing matching in this feature space, it is possible to precisely detect a mark without being affected by deformation of the mark. As a result, it is possible to perform the wafer positioning, shot area positioning, or other processing at a high precision and possible to transfer the desired patterns by exposure with a high definition. Further, as a result, it is possible to manufacture high quality electronic devices formed with fine patterns.

Further, at this time, in the method of this embodiment, it is possible to extract features even for space parts not marks. Therefore, it is possible to extract more of the information required for positioning. Further, according to the method of this embodiment, it is possible to define features without regard as to differences in line widths for patterns with different line widths. Therefore, it is possible to conserve the storage area for the templates, there is no longer a need to change the algorithms, parameters, etc., and the exposure apparatus or exposure system can be efficiently operated.

### Second Embodiment

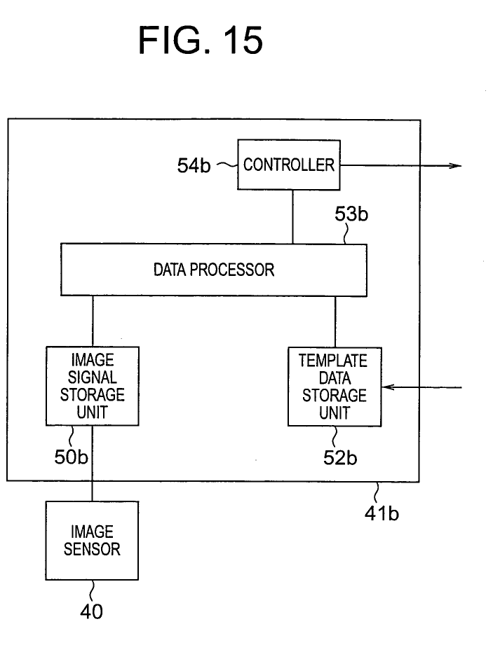

A second embodiment of the present invention will be explained with reference to FIG. 15 to FIG. 23. In the second embodiment, the method of generating a pattern model when forming a pattern on a wafer for pattern data input from various input sources, using an optical image deformation simulator to generate a pattern image (virtual model) obtained when obtaining an image of that pattern model, and using this to generate a template corresponding to deformation of the pattern will be explained. Further, the pattern detection using that template, the position detection based on the results of pattern detection, and the exposure based on the results of position detection will be explained.

Specifically, in the present embodiment as well, an exposure apparatus having an off-axis type alignment optical system for detecting an alignment mark (mark pattern) or circuit pattern formed on a wafer by image processing and using a template generated by the template generating method according to the present invention for positioning of the wafer or other substrate will be explained. The exposure apparatus is substantially the same in basic configuration as the exposure apparatus 100 explained in the first embodiment with reference to FIG. 1 to FIG. 4. Therefore, an explanation of the basic configuration of the exposure apparatus will be omitted. In the following explanation, the portions different from the first embodiment will be focused on for the explanation. Note that when referring to parts of exposure apparatus 100 in the explanation, the explanation will be given referring to FIG. 1 etc. using the same notations as in the first embodiment.

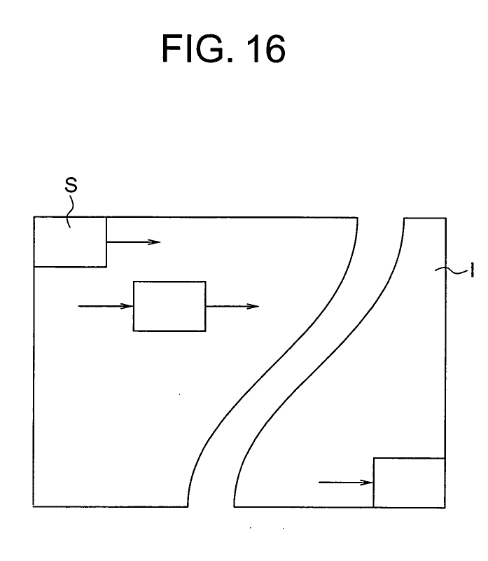

Specifically, in the exposure apparatus applying the present embodiment, the FIA processing unit differs in configuration from the exposure apparatus shown in the first embodiment. Below, the configuration of this FIA processing unit will be explained. FIG. 15 is a block diagram showing the internal configuration of an FIA processing unit 41b for template matching using a template according to the present invention. As shown in FIG. 15, the FIA processing unit 41b has an image signal storage unit 50b, template data storage unit 52b, data processor 53b, and controller 54b. Further, FIG. 16 is a view for explaining the alignment mark detection processing in the FIA processing unit 41b and shows a field area I, mark matching area S, and its searched state.

The image signal storage unit 50b stores the image signal input from the image sensor 40. The image signal storage unit 50b stores the image signal for the field area I as a whole sufficiently larger than the size of the mark matching area S corresponding to the size of the alignment mark for matching such as shown in FIG. 16.

The template data storage unit 52b stores the template data. The template data is reference pattern data for pattern matching with the image signal stored in the image signal storage unit 50b for detecting the desired mark (or pattern) to be detected. Therefore, as the template data, rather than being pattern data faithful to the original shape of the mark (or pattern) to be detected (shape in design or at time of formation), it is more effective that it be pattern data corresponding to the shape at the time of actual observation of the mark (or pattern) formed on the wafer through the imaging system of the alignment sensor. This is because the degree of similarity with the pattern data in the image signal observed becomes higher and the pattern can be suitably detected. Such template data is prepared by a computer system etc. separate from the exposure apparatus and stored in the template data storage unit 52b of the FIA processing unit 41b. This template data generating method according to the present invention will be explained in detail later.

The data processor 53b matches the image signal stored in the image signal storage unit 50b against a template stored in the template data storage unit 52b to detect the presence of a mark in the image signal. Further, when the image signal includes a mark, it detects that position information. The data processor 53b, as shown in FIG. 16, successively scans the field area I by a search area S corresponding to the size of the mark to be detected and performs matching between the image signal of the area and the template data at each position. Further, it detects the degree of similarity, the degree of correlation, etc. of the pattern data as evaluation values and, when the degree of similarity etc. is a predetermined threshold value or more, detects that the area has a mark. That is, it Judges that the image signal of that location includes an image of a mark. When it detects a mark, it finds at what position in the field its position is located. Due to this, it can obtain information AP2 relating to the mark center position of the wafer stage 9 when the image of the mark formed on the wafer W is accurately positioned at the center of the indicator marks 36a to 36d.

The controller 54b stores and reads out the image signal at the image signal storage unit 50b, stores and reads out the template data at the template data storage unit 52b, and controls the overall operation of the FIA processing unit so that the above matching or other processing at the data processor 53b is suitably performed.

Next, the method of generating a template according to the present invention stored in advance in the template data storage unit 52b will be explained. By generating template data for the desired mark or pattern and registering it in the template data storage unit 52b, the mark or pattern can be detected by the alignment sensor. Below, as the template generating method according to the present invention, the method of using a pattern for which deformation is predicted by an optical image deformation simulator and the method of direct use of an actually measured image will be explained. Note that the following explained template data generating processing is suitable for running by a predetermined program at an external computer apparatus etc. separate from the exposure apparatus 100. However, the invention is not limited to this. This may also be performed in the exposure apparatus 100. More specifically, this may be performed for example by the data processor 53b in the FIA processing unit 41b.

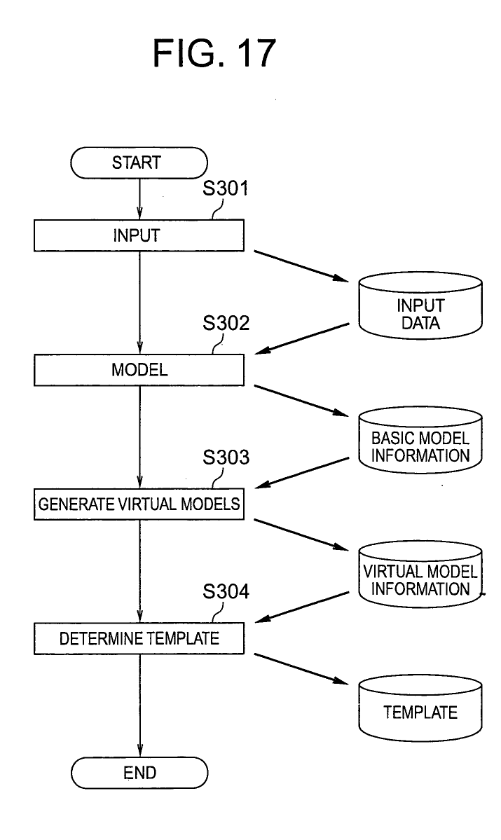

First, the method of using a pattern for which deformation is predicted by an optical image deformation simulator will be explained with reference to FIG. 17. FIG. 17 is a flow chart showing the template generation. First, the data of the pattern or mark to be detected is input (step S301). The method of inputting the data of the pattern or mark may be any method. For example, this may be obtained from the circuit design data, pattern or mark design data, CAD input data, or final pattern layout design data. Further, it is also possible to input a printed out pattern or mark image or handwritten indicated pattern or mark by a scanner etc. Further, for example, it is also possible to create a graphic for input by a word processor, simple graphic processing software, etc. operating on a personal computer etc. When inputting a letter pattern by handwriting or graphic processing software etc., it is also possible to recognize this once, then read out a font the same as that formed on the wafer so as to obtain pattern information formed on the water.

Note that separate from the method of direct use of an actually measured image as explained later, in this method as well, it is possible to use a pattern signal obtained by imaging of a pattern or mark actually formed on a wafer by an alignment sensor. In this case, deformation is further predicted for the fetched pattern. Whatever the case, first, in this process, information defining the shape of the desired pattern desired to be detected is input by any method.

Next, based on the input pattern data, a basic model of the pattern image formed on the wafer is generated (step S302). As explained above, at step S301, various methods may be used to input pattern data via various tools and means in various formats and forms of data. At step S302, in accordance with need, the circuit design data, layout information, etc. of the wafer is referred to and information relating to the shape of the input pattern is converted to information expressing the state of formation of the pattern on the actual wafer by a predetermined format and form of data.

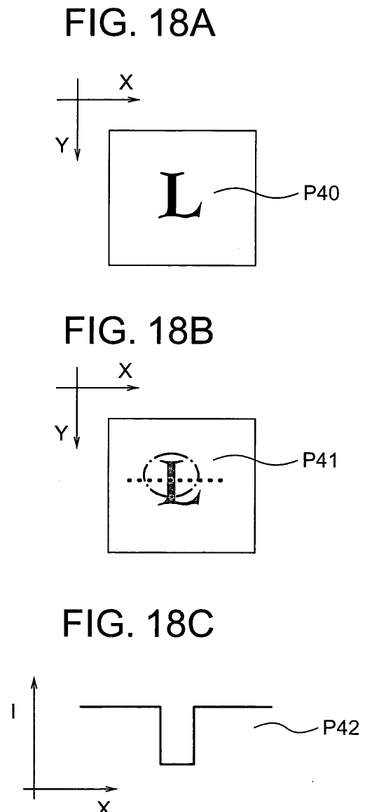

For example, at step S301, a simplified graphic processing software etc. is used to input a letter pattern L as shown in FIG. 18A. In this case, at step S302, based on the font information P40 of this letter pattern shown in FIG. 18A, image information in the case where this font is generated on the wafer is generated. Specifically, information showing the two-dimensional pattern P41 formed on the wafer as shown in FIG. 18B and luminance information of that pattern part (broken line part of FIG. 18B) as shown in FIG. 18C are generated. That is, by the processing of step S302, as shown in FIG. 18B and FIG. 18C, an image signal formed from the luminance information for each pixel where the letter line parts are black and low luminance in states and the space are as (background areas) are white and high luminance in states is generated as the basic model information for the input pattern.

After the pattern formed on the wafer is defined by a predetermined format and form of data, next an optical image deformation simulator is used to virtually generate a plurality of deformation patterns of the image of the basic model. These are stored as virtual model information (step S303). Reasons for deformation of the obtained pattern image include step differences on the wafer surface arising due to CMP and other conditions relating to the manufacturing method, the thickness of the resist film, the light transmittance of the resist film (light reflectance), and other conditions of the imaged side, lens aberration or focus conditions of the alignment sensor, illumination conditions (amount of illumination light, illumination wavelength, etc.), and other conditions at the imaging side, etc. (these all inclusively being referred to as “imaging conditions”). Among these, if the manufacturing method, line width of the pattern, parameters of the optical system, reflectance of the material of the resist film, etc. are known, it is possible to predict the change in shape with respect to the pattern of the basic model.

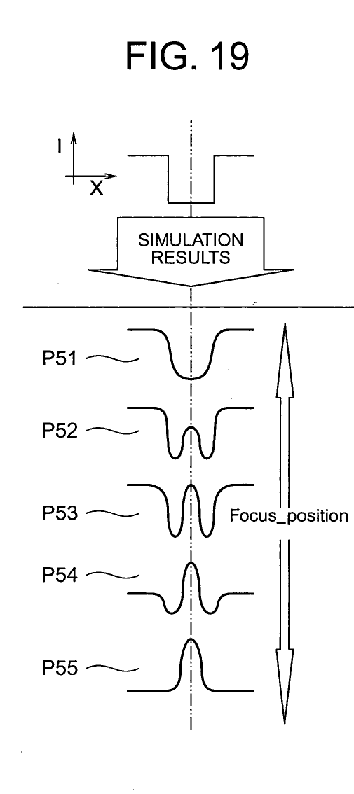

Further, at this time, by setting several parameters such as focus and resist thickness, it is possible to predict the pattern images actually obtainable (pattern signal waveforms). The optical image deformation simulator predicting this change in shape finds the deformation of the image due to the various above-mentioned factors and successively detects the deformation patterns (signal waveforms) able to arise. For example, by applying to the one-dimensional signal P42 shown in cross-section in FIG. 18C of the basic model pattern P41 shown in FIG. 18 B optical image deformation simulation considering change in the focus position of the alignment sensor, the deformation patterns P51 to P55 showing the one-dimensional signal in FIG. 19 are generated as virtual models.

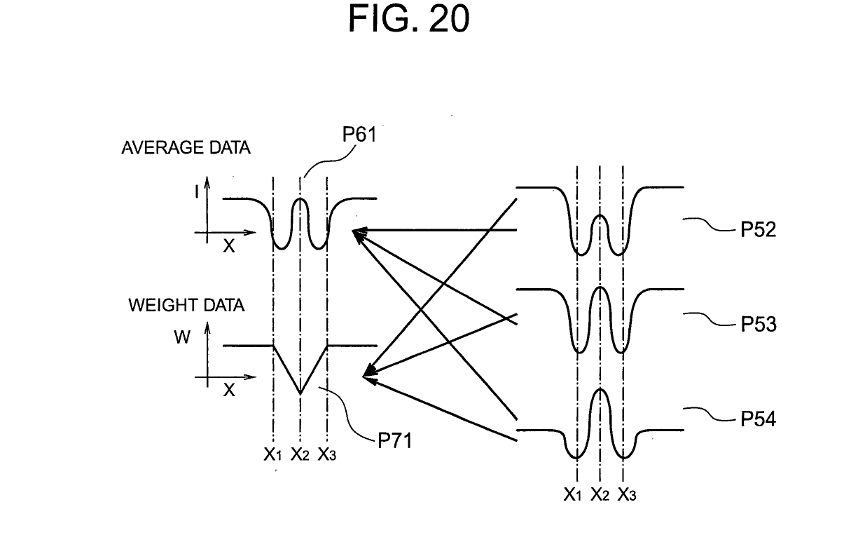

After performing optical image deformation simulation considering the assumed formation to predict image deformation, the template is determined based on the thus obtained signals (virtual models) (step S304). As the method of determination of the template, various methods may be considered. For example, when the predicted deformation is in the range of the pattern (signal waveform) P52 to pattern (signal waveform) P54 shown in FIG. 19, as shown in FIG. 20, for example, these patterns P52 to P54 may be averaged to calculate the pattern (signal waveform) P61 and this used as a template.

Further, it is also possible to set a width such as shown in the pattern P71 of FIG. 20 in accordance with the size (degree) of the change in the signal intensity I for example for each position X, obtained by comparison of the patterns (signal waveforms) P52 to P54 and weight the calculated averaged pattern (signal waveform) by this weight data to find a template. The meaning of the weight of the pattern P71 is the extraction of the degree of change of the signal waveform for each X position seen comparing the signal waveforms P52 to P54. At the position X2, the ratio of change of the signal (intensity) between the signal waveforms P52 to P54 is the greatest, so the weight W becomes the smallest, while at the positions X1 and X3, the ratio of change of the signal (intensity) between the signal waveforms P52 to P54 is the smallest so the weight W becomes the largest. If using this weight W to weight a template, template matching constantly stressing a location where the image does not deform becomes possible.

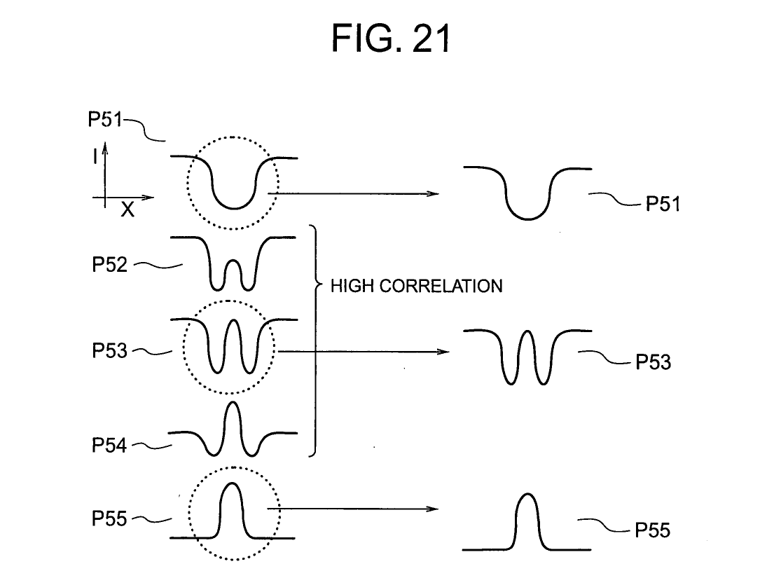

Further, when the result of the optical image deformation simulation is that the predicted deformation includes the patterns P51 to P55 shown in for example FIG. 19 and FIG. 21, it is effective to prepare a plurality of templates. As the method of selection of the patterns at that time, it is effective to calculate the correlation among the predicted patterns P51 to P55 and combine the high correlation data to form a single pattern. By registering low correlation patterns as templates, a smaller number of templates can be effectively used for matching.

For example, in the example shown in FIG. 21, assume that as a result of finding correlation of the patterns P51 to P55, it is detected that the correlation of the patterns P52 to P54 is high. In this case, the low correlation pattern P51 and pattern P55 are determined as templates as they are. Further, a single template is determined from the remaining high correlation patterns P52 to P54 and registered. At this time, to determine the template, as shown in FIG. 21, any pattern (in the example of FIG. 21, the pattern P53) may be used as the template or the above-mentioned method may be used to find the average of these patterns or weighted average of these pattern and use this as the template.

The template data generated in the above way is stored in the template data storage unit 52b of the FIA processing unit 41b of the exposure apparatus 100.

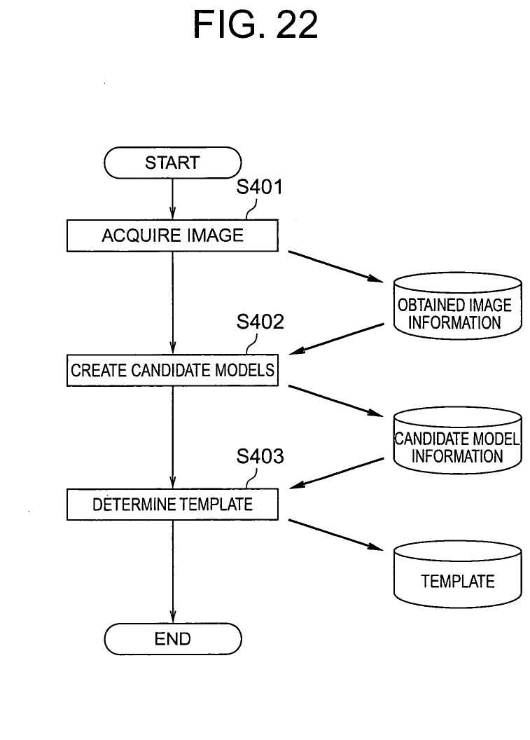

Next, the method of generating a template by directly using an actually measured image will be explained with reference to FIG. 22. FIG. 22 is a flow chart showing this template generation. First, a plurality of pattern images of a mark for generation of a template are obtained from a wafer actually produced by a predetermined process while changing the imaging conditions (step S401). The wafer at this time maybe separately produced for obtaining the actually measured images or a wafer produced in the actual production process may be used. The pattern images are preferably fetched via the alignment sensor of the exposure apparatus for registering the template. Next, the plurality of patterns (waveform signals) of the actually measured image input are converted to information expressed by a predetermined format and form of data and are registered as candidate models (step S402).

Further, after the candidate models are obtained, the template is directly determined based on the obtained candidate models (step S403). When registering the template, it is effective to select and register a suitable one based on the correlation with the plurality of candidate models. Therefore, in the same way as illustrated with reference to FIG. 20 or FIG. 21, an averaged pattern (waveform signal) or weighted averaged pattern (waveform signal) is generated or the correlation detected and only a pattern with a small correlation with the model is registered. The thus generated template data is stored in the template data storage unit 52b of the FIA processing unit 41b of the exposure apparatus 100.

Next, the operation of an alignment sensor including the FIA processing unit 41b will be explained focusing on the mark detection operation in the FIA processing unit 41b. The operation from the start of operation to when an image is acquired is the same as the operation of the FIA processing unit 41 of the above-mentioned first embodiment. That is, the main control system 15 drives the wafer stage 9 so that the mark on the wafer W enters the field of the alignment sensor. In this state, the illumination light of the alignment sensor is illuminated on the wafer W. The light reflected from the wafer W is formed on the indicator board 36, and the image of the mark of the wafer W and the indicator marks 36a, 36b, 36c, and 36d are formed on the image sensor 40. The information of the image formed on the image sensor 40 is fetched into the FIA processing unit 41b which then detects the position of the mark and outputs information AP2 relating to the mark center detection position of the wafer stage 9 when the image of the mark formed on the wafer W is accurately positioned at the center of the indicator marks 36a to 36d.

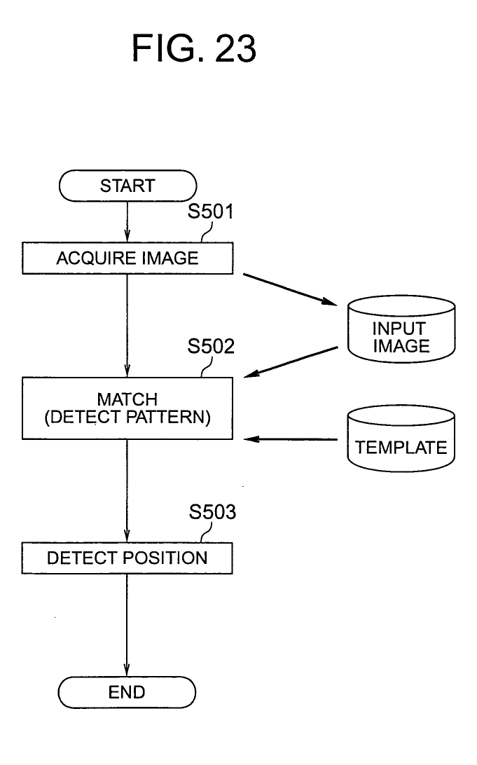

The operation for detecting the position of a mark from image information at the FIA processing unit 41b will be explained with reference to the flow chart of FIG. 23. First, the image signal storage unit 50b fetches and stores the image signal I in the sensor field from the sensor 40 (step S501). When the image signal I is stored in the image signal storage unit 50b, the data processor 53b performs matching based on a control signal from the controller 54b, (step S502). That is, as explained above with reference to FIG. 16, the data processor 53b successively scans the image signal I of the field area stored in the image signal storage unit 50b by the search area S corresponding to the size of the mark to be detected and matches the image signal of that area against the template data at each position. When a plurality of templates are registered, the matching is performed for each template. Further, when the degree of similarity and the degree of correlation between the template and image signal is a predetermined threshold value or more, it is judged that the area has a mark. Further, when a mark is detected, at what position in the field it is positioned is found. Note that for the calculation equation for finding the degree of correlation and degree of similarity between the image signal and template, it is possible to use any equation such as a correlation coefficient calculation equation, SSDA, etc. which gives a high evaluation value when the template and image signal are the same.

When the matching over the entire area of the image information of the field area stored in the image signal storage unit 50b results in detection of a mark, the position of the mark is detected based on the position of the extracted area at that time (step S503). Further, the data processor 53b outputs processing results indicating the fact that the image signal and template match, that is, the fact that a mark is detected, to the controller 54b. As a result, the controller 54b outputs this as information AP2 relating to the mark center position to the main control system 15 and ends the series of position detection.

On the other hand, when no mark is detected at step S503, under the control of the main control system 15 of the exposure apparatus 100, the wafer stage 9 is made to move via the stage controller 13 and drive system 14 to change the area on the wafer W entering the field of the alignment sensor. Further, the image of the field area is again fetched into the FIA processing unit 41b and the mark detection is repeated.

In the exposure apparatus 100, based on the information AP2 relating to the mark center detection position obtained by this processing, the main control system 15 drives the wafer stage 9 via the stage controller 13 and drive system 14 to relatively match the position at which the pattern formed on the reticle R is projected and the position of the wafer W and expose the pattern on the wafer W.

In this way, according to the exposure apparatus of the present embodiment and the template generating method relating to this, a user can easily set the template data. That is, it is possible to register as templates design data, CAD data, layout data, and other patterns or input handwritten letters, patterns, or any other patterns by a scanner etc. and register them as templates. Further, a mark or pattern generated by a word processor or graphic processing software etc. may be registered as a template. As a result, for example, it is possible to use any pattern included in the patterns for exposure as an alignment mark. Further, it is possible to detect by an alignment sensor a letter or other mark or pattern set by the user and for example able to be intuitively understand and use the functions of the alignment sensor of the exposure apparatus for various applications.

Further, the mark or pattern set by the user in this way is processed by an optical image deformation simulator to predict changes in shape of the image at the time of imaging and used as a template. Therefore, it is possible to generate from handwritten patterns, pattern design values, or other primitive input data a template able to handle changes in the image of a pattern due to imaging conditions even when the pattern image changes and consequently robust high precision template matching becomes possible. Further, by using an optical image deformation simulator to predict the shapes of patterns and generate a template, it is possible to generate a suitable template handling changes in shape even without actually operating an apparatus to produce a wafer. On the other hand, in the exposure apparatus of the present embodiment, it is possible to generate a template from an actually measured image of a mark or pattern formed on an actually produced wafer. Therefore, it is possible to generate a template handling changes in shape unable to be predicted by an optical image deformation simulation.

Further, with either templates based on pattern images predicting deformation or templates based on actually measured pattern images, when registering them as templates, for example, the correlation among the templates is calculated and only suitable templates are selected and registered. Therefore, it is possible to prevent a remarkable increase in the required storage capacity for templates or the processing time for template matching and possible to perform suitable template matching, in other words, FIA type alignment.

Further, as explained above, when generating a template, deformation of the pattern image is predicted. As a result, at the time of actual alignment processing, edge detection, binarization, or other pre-processing on the mark imaged from the wafer can be simplified. As a result, the configuration of the FIA alignment system can be simplified and the processing time can be shortened. Note that in the above-mentioned embodiment, the case of applying the technique of template matching in the present invention when using an FIA alignment system to multiply the observation power and make fine measurements (measure fine alignment mark positions designed for individual shots) was explained, but the present invention is not limited to this. It is also possible to apply the technique of the present invention when making the observation power of the FIA alignment system low and measuring a search use alignment mark so as to find the state of rotation of the wafer with respect to the wafer movement coordinate system (stage movement coordinate system). Further, it is also possible to use the present invention for both search measurements and fine measurements or use the present invention for only search measurements.

Device Manufacturing Method

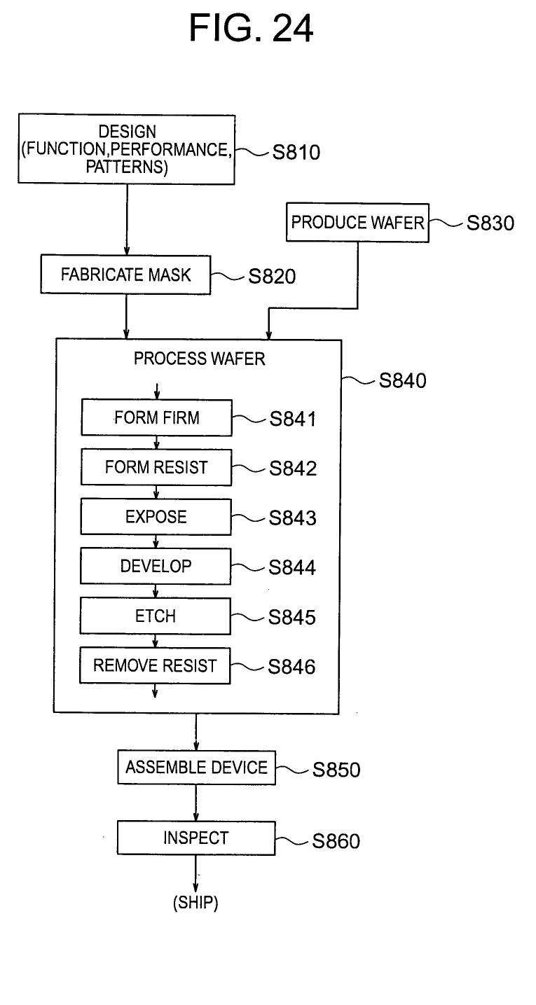

Next, the method of manufacturing a device using the above-mentioned exposure system in the lithography process will be explained with reference to FIG. 24. FIG. 24 is a flow chart of the process of production of for example an IC, LSI, or other semiconductor chip, liquid crystal panel, CCD, thin film magnetic head, micromachine, or other electronic device. As shown in FIG. 24, in the process of production of an electronic device, first, the functions and performance of the device such as the circuit design of an electronic device are designed and the patterns for realizing those functions are designed (step S810), Next, a reticle formed with the designed circuit patterns is fabricated (step S820). On the other hand, silicon or another material is used to produce a wafer (silicon substrate) (step S830).

Next, the reticle fabricated at step S820 and the wafer produced at step S830 are used to form the actual circuits etc. on the wafer by lithography (step S840). Specifically, first, the surface of the wafer is formed with an insulating film, electrode interconnect film, semiconductor film, or other thin film (step S841), then the entire surface of this thin film is coated with a photosensitive agent (resist) by a resist coating apparatus (coater) (step S842). Next, this resist-coated substrate is loaded onto a wafer holder, the reticle produced at step S830 is loaded on a reticle stage, and the patterns formed on the reticle are reduced and transferred onto the wafer (step S843). At this time, in the exposure apparatus, the above-mentioned positioning method according to the present invention is used to successively position each shot area of the wafer and successively copy the patterns of the reticle to the shot area.

After the exposure ends, the wafer is unloaded from the wafer holder and developed using a developer (step S844). Due to this, a resist image of the reticle patterns is formed on the wafer. Further, the finished developed wafer is etched using an etching apparatus (step S845) to remove the resist remaining on the surface of the wafer using for example a plasma ashing apparatus etc. (step S846). Due to this, each shot area of the wafer is formed with an insulating layer or electrode interconnects or other patterns. Further, by repeating this processing while changing reticles, the wafer is formed with the actual circuits etc.

After the wafer is formed with the circuits etc., the device is assembled (step S850). Specifically, the wafer is diced to divide it into individual chips, the chips are mounted in lead frames or packages and bonded to connect electrodes, and resin sealing and other packaging processing are performed. Further, the produced devices are subjected to operation confirmation tests, endurance tests, and other tests (step S860) and then shipped out as finished devices.

Modifications

The above explained embodiments were given for facilitating the understanding of the present invention and not for limiting the present invention. Therefore, the elements disclosed in the embodiments include all design changes or equivalents falling within the technical scope of the present invention.

For example, in the above-mentioned embodiments, the present invention was explained with reference to the example of the case of detecting the position information of a pattern (mark) formed on a wafer W, but the present invention may also be applied to the case of for example detecting position information of a pattern (mark) formed on a reticle R or a pattern (mark) formed on a glass plate. Further, in the above-mentioned embodiment, the explanation was given with reference to the example of applying the present invention to an off-axis type alignment sensor, but the present invention may also be applied to all apparatuses processing an image of a pattern (mark) by an imaging element to detect the position of the pattern (mark).

Further, the present invention may also be applied to a step-and-repeat type or step-and-scan type reduction projection type exposure apparatus or mirror projection type, proximity type, contact type, or other exposure apparatus. Further, the present invention may be applied to not only an exposure apparatus used for production of semiconductor elements and liquid crystal display elements, but also an exposure apparatus used for production of a plasma display, thin film magnetic heads, and imaging elements (CCD etc.), and an exposure apparatus for transferring circuit patterns to a glass substrate or silicon wafer etc. for producing a reticle. That is, the present invention may be applied without regard as to the exposure system of the exposure apparatus, application, etc.

Further, as the exposure light EL of the exposure apparatus 100 of the present embodiment, g-rays, i-rays, or light emitted from an KrF excimer laser, ArF excimer laser, or F2 excimer laser was used, but not only light emitted from a KrF excimer laser (248 nm), ArF excimer laser (193 nm), or F2 laser (157 nm), but also X-rays, electron beams, or other charged particle beams may also be used. For example, when using an electron beam, as an electron gun, it is possible to use thermal electron emission type lanthanum hexaboride (LaB6) or tantalum (Ta). Further, for example, it is possible to amplify a single wavelength laser of the infrared band or visible band emitted from a DFB semiconductor laser or fiber laser by a fiber amplifier doped with erbium (or both erbium and yttrium) and use a nonlinear optical crystal to convert this in wavelength to ultraviolet light and use the harmonic. Note that as a single wavelength oscillation laser, a yttrium doped fiber laser is used.

Note that the exposure apparatus according to the above-mentioned embodiment of the present invention (FIG. 1) can control the position of the substrate W with a good accuracy and at a high speed. To improve the throughput and enable exposure by a high exposure accuracy, illumination optical system, reticle R alignment system (not shown), the wafer stage 9, moving mirror 11, and laser interferometer 12 forming the wafer alignment system, the projection lens PL, and other elements shown in FIG. 1 are electrically, mechanically, or optically connected and assembled, then are adjusted overall (electrical adjustment, confirmation of operation, etc.). Note that the exposure apparatus is preferably produced in a clean room controlled in temperature and degree of cleanness.

Note that the present invention is not limited to the above-mentioned embodiments and may be modified in various ways within the scope of the present invention of course. Further, insofar as the domestic laws of the designated countries designated by this international application or elected countries elected by it allow, the disclosures of all of the above-mentioned publications are cited as part of the disclosure of the present specification. The present disclosure is related to the matter included in Japanese Patent Application No. 2003-146409 filed on May 23, 2003, Japanese Patent Application No. 2003-153821, filed on May 30, 2003, and Japanese Patent Application No. 2004-11901 filed on Jan. 20, 2004, the entire disclosures of which are explicitly incorporated by reference.

1. A method for generating a template used for template matching with a photoelectric conversion signal, including
a step of obtaining an image of an object to obtain a photoelectric conversion signal,
a step of extracting from said photoelectric conversion signal a feature component maintaining a predetermined state without being affected by at least one or both of the optical conditions at the time of obtaining said photoelectric conversion signal and process conditions given to said object from which said photoelectric conversion signal is obtained, and
a step of holding said extracted feature component as said template.

2. A template generating method as set forth in claim 1, wherein
said feature component includes symmetry relating to a plane of symmetry, axis of symmetry, or center of symmetry defined by a predetermined function, and
said predetermined state is a state where said plane of symmetry, said axis of symmetry, or said center of symmetry does not change regardless of at least one or both of the differences of said optical conditions and differences of said process conditions.

3. A template generating method as set forth in claim 2, wherein said symmetry is extracted by subjecting said photoelectric conversion signal to reversed autocorrelation processing.

4. A template generating method as set forth in claim 2, wherein a predetermined range near said plane of symmetry, said axis of symmetry, or said center of symmetry is excluded from the photoelectric conversion signal for detection of said feature component, and said feature component is extracted from the photoelectric conversion signal of a predetermined area outside of said plane of symmetry, said axis of symmetry, or said center of symmetry of this range.

5. A template generating method as set forth in claim 1, wherein said optical conditions include at least one or both of the focus state at the time of obtaining the photoelectric conversion signal in the step of obtaining said photoelectric conversion signal and conditions relating to the imaging system used for obtaining the photoelectric conversion signal.

6. A template generating method as set forth in claim 1, wherein said process conditions include conditions relating to a thin film coated on said object.

7. A pattern detecting method
obtaining an image of an area for detection on an object,
extracting from the obtained photoelectric conversion signal of the area for detection the feature component extracted when generating a template according to the template generating method of claim 1,
computing correlation between said extracted feature component and a template generated by the template generating method of claim 1, and
detecting the presence of a pattern corresponding to said template in said area for detection based on the results of said correlation computation.

8. A position detecting method
obtaining an image of an area for detection on an object,
extracting from the obtained photoelectric conversion signal of the area for detection the feature component extracted when generating a template according to the template generating method of claim 1,
computing correlation between said extracted feature components and a template generated by the template generating method of claim 1,
detecting a parameter corresponding to said template in said area for detection based on the results of said correlation computation, and
detecting the position of said object or a predetermined area on said object based on the position of the pattern corresponding to the template detected.

9. An exposure method
detecting the positions of one, a plurality of, or all of a predetermined area of a mask (reticle) on which a pattern for transfer is formed, a substrate for exposure, a predetermined area of said reticle, and a predetermined area of said substrate by the position detecting method of claim 8,
positioning said mask and said substrate relative to each other based on said detected positions, and
exposing said positioned substrate and transferring the pattern of said mask on to said substrate.

10. A device manufacturing method including a step of exposing the device pattern on a substrate using the exposure method of claim 9.

11. A program using a computer to generate a template used for template matching with a photoelectric conversion signal, which makes the computer realize
a function of extracting from a photoelectric conversion signal obtained from an object a predetermined feature component maintaining a predetermined state without being affected by at least one or both of optical conditions at the time of obtaining said photoelectric conversion signal and process conditions given to said object from which said photoelectric conversion signal is obtained and
a function of determining a template based on said extracted feature component.

12. A method of generating a template used when obtaining an image of an object and detecting a desired pattern on the object, including
a first step of inputting pattern data corresponding to the desired pattern,
a second step of generating a model of said pattern formed on said object based on the pattern data input at said first step,
a third step of virtually calculating a plurality of virtual models corresponding to the pattern signals obtained when obtaining an image of said model of the pattern generated at said second step while changing the imaging conditions, and
a fourth step of determining said template based on said plurality of virtual models calculated at said third step.

13. A template generating method as set forth in claim 12, wherein the pattern data input at said first step is one of design data relating to a pattern formed on said object, pattern data input by a user without using said design data, or a pattern signal obtained by obtaining an image of a pattern actually formed on said object.

14. A template generating method as set forth in claim 12, wherein said imaging conditions include at least one of lens aberration, numerical aperture, and focus state of a detection optical system used at the time of imaging or the wavelength of illumination light used at the time of development and the amount of illumination light.

15. A template generating method as set forth in claim 12, wherein said imaging conditions include at least one imaged side condition of a thickness of resist film coated over said pattern on said object, a light transmittance of said resist film, and processing applied to said object before said imaging.

16. A template generating method as set forth in claim 12, wherein said fourth step averages the plurality of virtual models calculated at said third step and uses said averaged virtual model as said template.

17. A template generating method as set forth in claim 12, wherein said fourth step averages the plurality of virtual models calculated at said third step, weights the averaged virtual model in accordance with a magnitude of change between said plurality of virtual models, and uses said weighted averaged virtual model as said template.

18. A template generating method as set forth in claim 12, wherein said fourth step calculates the correlation among said plurality of virtual models calculated at said third step and determines the model used as said template based on said calculated correlation.

19. A template generating method as set forth in claim 18, wherein said fourth step selects said virtual model with a small correlation from said plurality of virtual models based on said calculated correlation and uses said selected virtual model as said template.

20. A method of generating a template used when obtaining an image of an object through a detection optical system and detecting a desired pattern on the object, including
a first step of obtaining an image of said desired pattern on said object while changing the imaging conditions,
a second step of setting signal information corresponding to the desired pattern obtained for each of the imaging conditions as a candidate model of said template, and
a third step of averaging the plurality of candidate models set at said second step and using said averaged candidate model as said template.

21. A template generating method as set forth in claim 20, wherein said third step averages the plurality of candidate models set at said second step, weights the averaged candidate model in accordance with a magnitude of change between said plurality of candidate models, and uses said weighted averaged candidate model as said template.

22. A method of generating a template used when obtaining an image of an object and detecting a desired pattern on the object, including
a first step of obtaining an image of said desired pattern on said object while changing the imaging conditions,
a second step of setting signal information corresponding to said desired pattern obtained for each of said imaging conditions as a candidate model of said template, and
a third step of calculating correlation among the plurality of candidate models set at said second step and determining the candidate model used from said plurality of candidate models as said template based on the results of correlation calculated.

23. A template generating method as set forth in claim 22, wherein said third step selects said candidate model with a small correlation from said plurality of candidate models based on said calculated correlation and uses said selected candidate model as said template.

24. A pattern detecting method using a template generated using the template generating method of claim 12 to perform template matching with a signal obtained by imaging of said object.

25. A position detecting method using the pattern detecting method of claim 24 to detect position information of said desired pattern formed on said object.

26. An exposure method exposing a substrate by a pattern formed on a mask,
detecting position information of at least one of said mask and said substrate by the position detecting method of claim 25,
relatively positioning said mask and said substrate based on said detected position information, and
exposing said positioned substrate by said pattern of said mask.

27. A device manufacturing method including a step of exposing a device pattern on a substrate using the exposure method of claim 26.

28. An apparatus for generating a template used when obtaining an image of an object and detecting a desired pattern on that object, having
an input means for inputting pattern data corresponding to said desired pattern,
a model generating means for generating a model of said pattern formed on said object based on said input pattern data,
a virtual model calculating means for virtually calculating a plurality of virtual models corresponding to the pattern signals obtained when obtaining an image of said model of the pattern generated while changing the imaging conditions, and
a template determining means for determining said template based on said calculated plurality of virtual models.

29. A template generating apparatus as set forth in claim 28, wherein said imaging conditions include one or both of imaging system conditions including at least one of lens aberration, numerical aperture, and focus state of a detection optical system used at the time of imaging or the wavelength of illumination light used at the time of development and the amount of illumination light and at least one imaged side condition of a thickness of resist film coated over said pattern on said object, a light transmittance of said resist film, and processing applied to said object before said imaging.

30. A template generating apparatus as set forth in claim 28, wherein said template determining means averages the plurality of virtual models calculated by said virtual model calculating means and uses said averaged virtual model as said template.

31. A template generating apparatus as set forth in claim 28, wherein said template determining means calculates the correlation among said plurality of virtual models calculated by said virtual model calculating means and determines the model used as said template based on said calculated correlation.

32. An apparatus for generating a template used when obtaining an image on an object and detecting a desired pattern on said object, having
an imaging means for obtaining an image of said desired pattern on said object while changing the imaging conditions,
a candidate model setting means for setting signal information corresponding to said desired pattern obtained for each of said imaging conditions as a candidate model of said template, and
a template determining means for averaging the plurality of candidate models set at said second step and using said averaged candidate model as said template.

33. An apparatus for obtaining an image on an object and generating a template used when detecting a desired pattern on said object, having
an imaging means for obtaining an image of said desired pattern on said object while changing the imaging conditions,
a candidate model setting means for setting signal information corresponding to said desired pattern obtained for each of said imaging conditions as a candidate model of said template, and
a template determining means for calculating a correlation among the plurality of candidate models set and determining a candidate model used as said template from said plurality of candidate models based on said calculated correlation.

34. A position detecting apparatus as set forth in claim 28, having
a pattern detecting means for using a template generated by said template generating apparatus for template matching with a signal obtained by imaging of said object to detect a pattern on said object and
a position detecting means for detecting a position of said pattern formed on said object based on said pattern detection results.

35. An exposure apparatus for exposing a substrate by a pattern formed on a mask, having
a position detecting apparatus of claim 34 for detecting position information of at least one of said mask and said substrate,
a positioning means for relatively positioning said mask and said substrate based on said detected position information, and
an exposing means for exposing said positioned substrate by the pattern of said mask.

36. A program for generating a template used when obtaining an image of an object and detecting a desired pattern on the object, which makes the computer realize
a function of inputting pattern data corresponding to said desired pattern,
a function of generating a model of said pattern formed on said object based on said input pattern data,
a function of virtually calculating a plurality of virtual models corresponding to the pattern signals obtained when obtaining an image of said model of the pattern generated while changing the imaging conditions, and
a function of determining said template based on said calculated plurality of virtual models.

37. A template generating program as set forth in claim 36, wherein said function for determining the template averages the plurality of virtual models calculated and uses said averaged virtual model as said template.

38. A template generating program as set forth in claim 36, wherein said template determining function calculates the correlation among said plurality of virtual models calculated and determines the model used as said template based on said calculated correlation.

39. A program for generating a template used when obtaining an image on an object and detecting a desired pattern on said object, which makes the computer realize
a function of obtaining an image of said desired pattern on said object while changing the imaging conditions,
a function of setting signal information corresponding to said desired pattern obtained for each of said imaging conditions as a candidate model of said template, and
a function of averaging the plurality of candidate models set and using said averaged candidate model as said template.

40. A program for obtaining an image on an object and generating a template used when detecting a desired pattern on said object, which makes the computer realize
a function of obtaining an image of said desired pattern on said object while changing the imaging conditions,
a function of setting signal information corresponding to said desired pattern obtained for each of said imaging conditions as a candidate model of said template, and
a function of calculating a correlation among the plurality of candidate models set and determining a candidate model used as said template from said plurality of candidate models based on said calculated correlation.
